(19) United States
(12) Patent Application Publication
(10) Pub. No.: US 2026/0012525 A1
(43) Pub. Date: Jan. 8, 2026

(54) ELECTRONIC APPARATUS INCLUDING FLEXIBLE DISPLAY

(71) Applicant: SAMSUNG ELECTRONICS CO., LTD., Suwon-si (KR)

(72) Inventors: Jeongho KANG, Suwon-si (KR); Namwoo KIM, Suwon-si (KR); Byoungjun KIM, Suwon-si (KR); Changi PARK, Suwon-si (KR); Hyerim BAE, Suwon-si (KR); Seho CHANG, Suwon-si (KR); Sungyun CHOI, Suwon-si (KR); Junyoung CHOI, Suwon-si (KR); Hyunchul HONG, Suwon-si (KR)

(21) Appl. No.: 19/327,136

(22) Filed: Sep. 12, 2025

Related U.S. Application Data
(63) Continuation of application No. PCT/KR2024/005955, filed on May 2, 2024.

(30) Foreign Application Priority Data
Jun. 23, 2023 (KR) 10-2023-0081506
Jul. 27, 2023 (KR) 10-2023-0098496

(51) Int. Cl. H04M 1/02

(52) U.S. Cl. CPC H04M 1/0268; H04M 1/0216

(57) ABSTRACT

A multi-foldable electronic device includes a first housing including a lateral side surface, a second housing, a third housing, a flexible display facing each of the first housing and the second housing, a first hinge structure rotatably connecting the first housing to the second housing, and a second hinge structure rotatably connecting the second housing to the third housing. The first hinge structure and the second hinge structure are configured to provide an unfolded state and a plurality of folded states of the multi-foldable electronic device. The lateral side surface may include a pattern including a plurality of protrusions.

### CROSS-REFERENCE TO RELATED APPLICATIONS

This application is a continuation application of International Application No. PCT/KR2024/005955 designating the United States and filed on May 2, 2024, in the Korean Intellectual Property Receiving Office and claiming priority to Korean Patent Application No. 10-2023-0081506, filed on Jun. 23, 2023 and Korean Patent Application No. 10-2023-0098496, filed on Jul. 27, 2023 in the Korean Intellectual Property Office, the disclosures of which are incorporated by reference herein in their entireties.

### BACKGROUND

### (1) Field

Various embodiments to be described later relate to an electronic device including a flexible display.

### (2) Description of the Related Art

An electronic device including a large-screen display may increase user utilization. As a demand for an electronic device having high portability increases, the electronic device may include a deformable display. The deformable display may be slidably deformable, rollably deformable, or foldably deformable.

The above-described information may be provided as a related art for the purpose of helping understanding of the present disclosure. No argument or decision is made as to whether any of the above description may be applied as a prior art related to the present disclosure.

### SUMMARY

According to an embodiment, a multi foldable electronic device may include a first housing including a first surface and a first lateral side. The multi foldable electronic device may include a second housing, including a second surface, rotatably coupled with the first housing. The multi foldable electronic device may include a third housing, including a third surface, rotatably coupled with respect to the second housing. The multi foldable electronic device may include a flexible display, disposed on the first surface, the second surface, and the third surface, and including a first display area disposed on the first surface, a second display area disposed on the second surface, and a third display area disposed on the third surface. The multi foldable electronic device may include a first hinge structure, disposed between the first housing and the second housing and rotatably connecting the first housing and the second housing, and a second hinge structure, disposed between the second housing and the third housing and rotatably connecting the second housing and the third housing. The first hinge structure and the second hinge structure may be configured to provide an unfolded state and a plurality of folded states, the plurality of folded states including a first folded state in which the first housing and the second housing are folded to each other, and a second folded state in which the second housing and the third housing are folded to each other. A width between the first surface and the second surface of the first hinge structure may be narrower than a width between the second surface and the third surface of the second hinge structure. The first lateral side may be configured to include a pattern including a plurality of protrusions.

According to an embodiment, a multi foldable electronic device may include a first housing including a first surface, and lateral sides extending from the first surface, a second housing including a second surface, a third housing including a third surface, and a flexible display disposed on the first surface, the second surface, and the third surface. The multi foldable electronic device may include a first hinge structure, disposed between the first housing and the second housing and rotatably connecting the first housing and the second housing, and a second hinge structure, disposed between the second housing and the third housing and rotatably connecting the second housing and the third housing. The first hinge structure and the second hinge structure may be configured to provide an unfolded state in which the first surface, the second surface, and the third surface face the same direction, and a plurality of folded states in which at least one of the first surface, the second surface, and the third surface face a different direction. The lateral sides may include a plurality of protrusions, a pattern including a plurality of grooves formed between the plurality of protrusions, and an inclined surface having an incline with respect to the first surface, and a first lateral side configured to face at least a portion of the flexible display in the plurality of folded states.

### BRIEF DESCRIPTION OF THE DRAWINGS

FIG. 1 is a block diagram of an electronic device in a network environment according to various embodiments.

FIG. 2A illustrates a perspective view of an unfolded state of an electronic device according to an embodiment.

FIG. 2B illustrates a perspective view of a first folded state of an electronic device according to an embodiment.

FIG. 2C illustrates a perspective view of a second folded state of an electronic device according to an embodiment.

FIGS. 3A and 3B illustrate a side view and an enlarged perspective view of a portion of an electronic device in a first folded state according to an embodiment.

FIGS. 3C and 3D illustrate a side view and an enlarged perspective view of a portion of an electronic device in a first folded state according to an embodiment.

FIG. 4A illustrates a perspective view of an electronic device in a first folded state according to an embodiment. FIGS. 4B and 4C illustrate enlarged perspective views of portions of the electronic device of FIG. 4A.

FIG. 4D is a partial cross-sectional view of an electronic device in a second folded state cut along line A-A′ of FIG. 2C according to an embodiment.

FIG. 4E is a partial cross-sectional view of an electronic device in a second folded state cut along line B-B′ of FIG. 2C according to an embodiment.

FIG. 4F is a partial cross-sectional view of an electronic device in a second folded state cut along line C-C′ of FIG. 2C according to an embodiment.

FIG. 5A is a top plan view of an electronic device in a first folded state according to an embodiment.

FIG. 5B illustrates a portion of an electronic device according to an embodiment.

FIGS. 6A and 6B illustrate a portion of an electronic device in a first folded state according to an embodiment.

FIG. 7A illustrates a portion of an electronic device in a first folded state according to an embodiment.

FIG. 7B is a top plan view of an electronic device in a first folded state according to an embodiment.

FIG. 8A illustrates a perspective view of an electronic device in a first folded state according to an embodiment. FIGS. 8B and 8C illustrate enlarged perspective views of portions of the electronic device of FIG. 8A.

### DETAILED DESCRIPTION

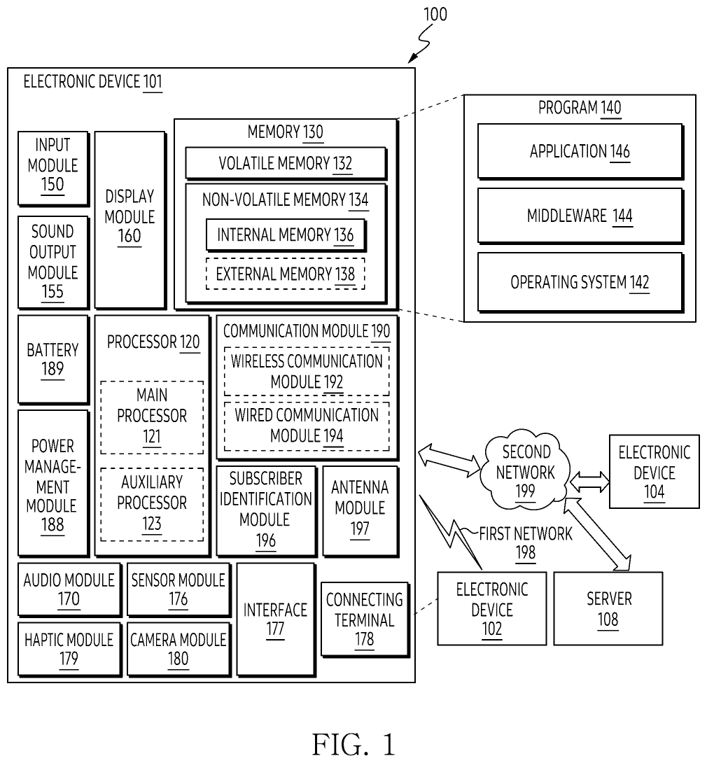

FIG. 1 is a block diagram of an electronic device 101 in a network environment 100 according to various embodiments.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108.

According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mm Wave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of Ims or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

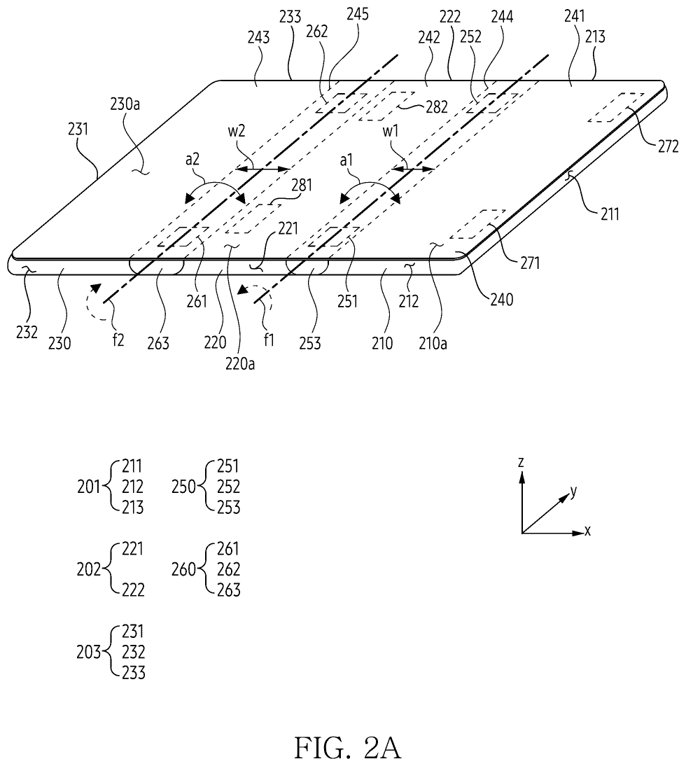

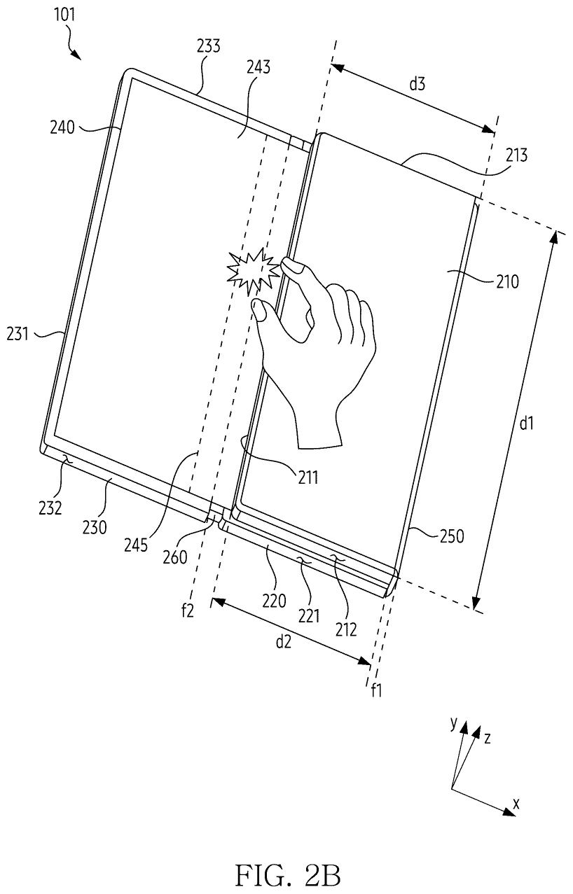

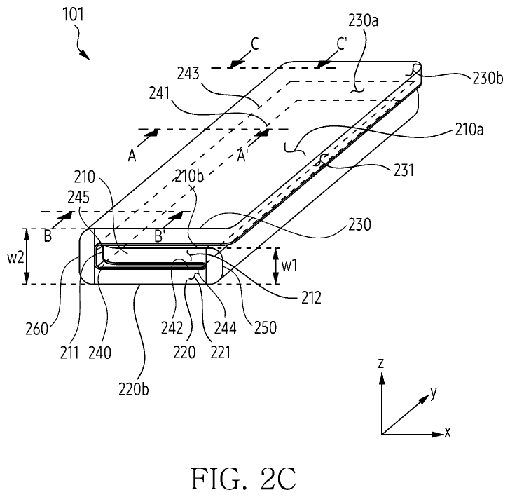

For example, a display (or a display panel) of the display module 160 may be flexible. For example, the display may include a display area exposed outside a housing of the electronic device 101 which provides at least a portion of an outer surface of the electronic device 101. For example, since the display has flexibility, at least a portion of the display may be rollable into the housing or slidable into the housing. For example, a size of the display area may be changed according to a size of the at least a portion of the display rollable into the housing or slid into the housing. For example, the electronic device 101 including the display may be in a plurality of states including a first state providing the display area having a first size and a second state providing the display area having a second size different from the first size. For example, the first state may be illustrated through a description of FIGS. 2A and 2B.

FIG. 2A illustrates an electronic device which is unfolded (e.g., an unfolded state) according to an embodiment. FIG. 2B illustrates an electronic device which is firstly folded (e.g., a first folded state) according to an embodiment. FIG. 2C illustrates an electronic device which is secondly folded (e.g., a second folded state) according to an embodiment.

A display (e.g., the display module 160 of FIG. 1) of an electronic device 101 may be foldable at least once (e.g., at a first location). The display may be referred to as a foldable display or a flexible display in terms of having a structure which is foldable. The electronic device 101 may be referred to as a foldable electronic device or a flexible electronic device in terms of including a display which is foldable. The electronic device 101 may be referred to as a multi foldable electronic device in terms of including a display which is foldable multiple times (e.g., at more than one location). The electronic device 101 which may be referred to as the multi foldable electronic device may have a plurality of folding axes (e.g., a first folding axis f1 and a second folding axis f2).

Referring to FIGS. 2A, 2B, and 2C, the electronic device 101 may include a first housing 210, a second housing 220, a third housing 230, a flexible display 240, a first hinge structure 250, and a second hinge structure 260. The first housing 210 may include a first surface 210a. The second housing 220 may include a second surface 220a. The third housing 230 may include a third surface 230a. The second housing 220 may be rotatably coupled to the first housing 210. The third housing 230 may be rotatably coupled to the second housing 220. The first housing 210 may be rotatably coupled to the third housing 230 vis the second housing 220.

According to an embodiment, the flexible display 240 may be disposed on a surface which the first housing 210, the second housing 220, and the third housing 230 form. The flexible display 240 may be disposed on the first surface 210a, the second surface 220a, and the third surface 230a. For example, when referring to FIG. 2A, the first surface 210a, the second surface 220a and the third surface 230a together with each other may be referred to as a front surface of the electronic device 101 in an unfolded state of the electronic device 101. In an embodiment, the flexible display 240 or another component of the electronic device 101 may define the first surface 210a, the second surface 220a and the third surface 230a at locations respectively corresponding to the first housing 210, the second housing 220, and the third housing 230. That is, the flexible display 240 or the other component may define the collective front surface of the electronic device 101, without being limited thereto.

For example, the first housing 210 may further include a fourth surface 210b opposite to the first surface 210a. The second housing 220 may further include a fifth surface 220b opposite to the second surface 220a. The third housing 230 may further include a sixth surface 220b opposite to the third surface 230a. The fourth surface 210b, the fifth surface 220b, and the sixth surface 230b may together be referred to as a rear surface of the electronic device 101 in the unfolded state of the electronic device 101. However, it is not limited thereto, and the electronic device 101 includes the plurality of folding axes, thereby including a plurality of surfaces forming the front surface in the unfolded state of the electronic device 101 and a plurality of other surfaces forming the rear surface which is opposite to the front surface.

According to an embodiment, the electronic device 101 may further include a cover display (not illustrated) disposed on the sixth surface 230b opposite the third surface 230a of the third housing 230. For example, the cover display may be spaced apart from the flexible display 240 by the third housing 230. For example, when referring to FIG. 2C, the cover display disposed on the sixth surface 230b may be configured to provide visual information to outside the electronic device 101, such as to a user, in the second folded state. However, it is not limited thereto. According to an embodiment, at least a portion of a camera module (e.g., the camera module 180 of FIG. 1) of the electronic device 101 may be exposed to the outside (e.g., to outside the electronic device 101) through the fifth surface 220b opposite to the second surface 220a of the second housing 220. For example, the camera module 180 may include at least one lens (not illustrated) for receiving external input such as light from the outside. At least a portion of the at least one lens may be exposed through the fifth surface 220b of the second housing 220. The electronic device 101 may provide a variety of user experiences to the user in a plurality of folded states of the electronic device 101 by including the camera module 180 at least partially exposed through the fifth surface 220b of the second housing 220.

According to an embodiment, the flexible display 240 may include a first display area 241, a second display area 242, and a third display area 243. The first display area 241 may be disposed on (or corresponding to) the first surface 210a of the first housing 210. The first display area 241 may be an area (e.g., a planar area) which is not deformed by being coupled to the first surface 210a (e.g., fixedly coupled instead of deformably or movably coupled). The second display area 242 may be disposed on the second surface 220a of the second housing 220. The second display area 242 may be an area which is not deformed by being coupled to the second surface 220a. The third display area 243 may be disposed on the third surface 230a of the third housing 230. The third display area 243 may be an area which is not deformed by being coupled to the third surface 230a. Since the first display area 241, the second display area 242, and the third display area 243 substantially form a plane, they may be referred to as a plane area. That is, the first display area 241, the second display area 242, and the third display area 243 may be coplanar with each other by together forming the plane.

According to an embodiment, the first housing 210 may include a first set of lateral sides 201 extending from the first surface 210a. The second housing 220 may include a second set of lateral sides 202 extending from the second surface 220a. The third housing 230 may include a third set of lateral sides 203 extending from the third surface 230a. The first set of lateral sides 201 may include a first lateral side 211, a second lateral side 212 in contact with the first lateral side 211 such as to meet the first lateral side 211 at a corner, and a third lateral side 213 in contact with the first lateral side 211 and facing the second lateral side 212. The second set of lateral sides 202 may include a fourth lateral side 221 and a fifth lateral side 222 facing the fourth lateral side 221. The third set of lateral sides 203 may include a sixth lateral side 231, a seventh lateral side 232 in contact with the sixth lateral side 231, and an eighth lateral side 233 in contact with the sixth lateral side 231 and facing the seventh lateral side 232. For example, the first lateral side 211 may be exposed to the outside of the multi foldable electronic device 101 when the multi foldable electronic device 101 is in the unfolded state. For example, the first lateral side 211 may be parallel to the first folding axis f1. For example, the first lateral side 211 may be positioned above a fifth display area 245 when the multi foldable electronic device 101 is in the first folded state to be described later.

For example, the first set of lateral sides 201 may be disposed between the first surface 210a of the first housing 210 and the fourth surface 210b opposite the first surface 210a. The first set of lateral sides 201 may surround a space between the first surface 210a and the fourth surface 210b together with the first hinge structure 250. For example, the second set of lateral sides 202 may be disposed between the second surface 220a of the second housing 220 and the fifth surface 220b opposite the second surface 220a. The second set of lateral sides 202 may surround a space between the second surface 220a and the fifth surface 220b together with the first hinge structure 250 and the second hinge structure 260. For example, the third set of lateral sides 203 may be disposed between the third surface 230a of the third housing 230 and the sixth surface 230b opposite the third surface 210a. The third set of lateral sides 203 may surround a space between the third surface 230a and the sixth surface 230b together with the second hinge structure 260.

For example, when referring to FIGS. 2A and 2B, at least a portion of the first set of lateral sides 201 of the first housing 210 may be gripped by the user in order for the electronic device 101 to be changed from the first folded state to the unfolded state or from the unfolded state to the first folded state. For example, when referring to FIGS. 2B and 2C, at least a portion of the third set of lateral sides 203 of the third housing 230 may be gripped by the user in order for the electronic device 101 to be changed from the second folded state to the first folded state or from the first folded state to the second folded state. By the grip of the user, the electronic device 101 may be changed from the unfolded state to a plurality of folded states or from the plurality of folded states to the unfolded state.

According to an embodiment, the first hinge structure 250 may rotatably connect the first housing 210 and the second housing 220 to each other. The first hinge structure 250 may be disposed between the first housing 210 and the second housing 220. The second hinge structure 260 may rotatably connect the second housing 220 and the third housing 230 to each other. The second hinge structure 260 may be disposed between the second housing 220 and the third housing 230. For example, the first hinge structure 250 may be a structure connecting the first housing 210 and the second housing 220 so that the first housing 210 is rotatable with respect to the second housing 220 about a respective folding axis. For example, the second hinge structure 260 may be a structure connecting the third housing 2300 and the second housing 220 so that the third housing 230 is rotatable with respect to the second housing 220 about a respective folding axis. For example, the first hinge structure 250 may provide the first folding axis f1 between the first housing 210 and the second housing 220 so that the first housing 210 is rotatable with respect to the second housing 220. For example, the second hinge structure 260 may provide the second folding axis f2 between the third housing 230 and the second housing 220 so that the third housing 230 may rotate with respect to the second housing 220.

It has been described that the electronic device 101 includes the first hinge structure 250 and the second hinge structure 260, but it is not limited thereto. The electronic device 101 may be folded more than once by including a plurality of hinge structures including the first hinge structure 250 and the second hinge structure 260. The electronic device 101 may provide a variety of user experiences to the user by including a plurality of folding axes provided by the plurality of hinge structures.

Referring to FIG. 2A, the first hinge structure 250 and the second hinge structure 260 may be configured to provide an unfolded state in which the first surface 210a, the second surface 220a, and the third surface 230a face the same direction. The unfolded state of the electronic device 101 may be a state in which the first surface 210a, the second surface 220a, and the third surface 230a face substantially the same first direction (e.g., a +z direction). A plane may be defined by two directions crossing each other, like the y direction and the x direction. A thickness of the electronic device 101 and various components or layers thereof may be defined along a direction crossing the plane, such as the z direction. A thickness direction of the electronic device 101 and various components or layers thereof may be defined along the z direction.

For example, the electronic device 101 may be unfolded in the unfolded state. The unfolded state may be referred to as a state in which the first housing 210, the second housing 220, and the third housing 230 are unfolded. In the unfolded state, the first housing 210, the second housing 220, and the third housing 230 may form a substantially flat. For example, the first surface 210a, the second surface 220a, and the third surface 230 respectively included in the first housing 210, the second housing 220, and the third housing 230 may be formed substantially flat (e.g., in a same plane). When the electronic device 101 including the first housing 210, the second housing 220, and the third housing 230 is in the unfolded state, the first surface 210a, the second surface 220a, and the third surface 230a may form a substantially flat plane, such as to be coplanar with each other. For example, the unfolded state may be a state in which the first display area 241, the second display area 242, and the third display area 243 of the flexible display 240 face substantially the same first direction (e.g., the +z direction). For example, the unfolded state may be a state in which deformable areas (e.g., a fourth display area 244 and the fifth display area 245) of the flexible display 240 are unfolded. For example, the unfolded state may be a state in which a first angle a1 between the first housing 210 and the second housing 220 and a second angle a2 between the second housing 220 and the third housing 230 are substantially 180 degrees, respectively.

Referring to FIGS. 2B and 2C, the first hinge structure 250 and the second hinge structure 260 may be configured to provide a plurality of folded states in which the first surface 210a, the second surface 210b, and the third surface 230a face different directions. According to an embodiment, the plurality of folded states may mean states in which at least one of the first surface 201a and the third surface 230a is inclined with respect to the second surface 220a. For example, the plurality of folded states may mean states in which the second surface 220a faces the first direction (e.g., the +z direction) and the at least one of the first surface 210a the third surface 230a faces a direction different from the first direction. For example, the plurality of folded states may be states in which the first surface 210a, the second surface 220a, and the third surface 230a are not formed in a same plane. For example, the plurality of folded states may be states in which at least one of the first display area 241, the second display area 242, and the third display area 243 of the flexible display 240 faces a different direction from each other. For example, the plurality of folded states may be in a state in which at least a portion of the deformable areas (e.g., the fourth display area 244 and the fifth display area 245) are bent. For example, the plurality of folded states may include states in which the first angle a1 between the first housing 210 and the second housing 220 is positioned within a range of 0° or more and less than about 180°. The plurality of folded states may include states in which the second angle a2 between the second housing 220 and the third housing 230 is positioned within a range of 0° or more and less than 180°.

Referring to FIG. 2B, the first folded state of the electronic device 101 may be a state among the plurality of folded states of the electronic device 101, in which a second surface (e.g., a second surface 220a of FIG. 2A) and a third surface (e.g., a third surface 230a of FIG. 2A) face the first direction (e.g., the +z direction), and the first surface 210a faces a second direction (e.g., a −z direction) opposite to the first direction. For example, the first folded state may be a state in which the second surface 220a and the third surface 230a substantially form a plane, and the first surface 210a faces the second surface 220a. For example, the first folded state may be a state in which the second display area 242 and the third display area 243 face the first direction (e.g., the +z direction), and the first display area 241 faces the second direction (e.g., the −z direction) opposite to the first direction. For example, the first folded state may be a state in which the fourth display area 244 is bent to the maximum extent (e.g., completely folded) and the fifth display area 245 is unfolded.

Referring to FIG. 2C, the second folded state of the electronic device 101 may be a state among the plurality of folded states of the electronic device 101, in which the second surface 220a faces the first direction (e.g., the +z direction), and the first surface 210a and the third surface 230a face the second direction (e.g., the −z direction) opposite to the first direction. For example, the second folded state may be a state in which the second surface 220a faces the first surface 210a and the third surface 230a faces the fourth surface 210b opposite the first surface 210a. For example, the second folded state may be a state in which the first housing 210 is positioned between the second housing 220 and the third housing 230 along a thickness direction of the maximally folded electronic device 101. For example, the second folded state may be a state in which the first housing 210 is disposed between the second display area 242 and the third display area 243. For example, the second folded state may be a state in which the second display area 242 faces the first direction (e.g., the +z direction), and the first display area 241 and the third display area 243 face the second direction (e.g., the −z direction) opposite to the first direction. For example, the second folded state may be a state in which the fourth display area 244 is bent to the maximum and the fifth display area 245 faces the first lateral side 211. For example, in the second folded state, the first housing 210, the second housing 220, and the third housing 230 may be stacked in the first direction (e.g., the +z direction).

Referring back to FIGS. 2A, 2B, and 2C, the first display area 241 of the flexible display 240 may face the second display area 242 in the first folded state among the plurality of folded states of the electronic device 101. The fifth display area 245 may face the first lateral side 211 of the first housing 210 in the second folded state among the plurality of folded states.

According to an embodiment, the first hinge structure 250 may include a plurality of first hinges 251 and 252. The second hinge structure 260 may include a plurality of second hinges 261 and 262. The first hinges 251 and 252 may be disposed between the first housing 210 and the second housing 220. The first hinges 251 and 252 may rotatably connect the first housing 210 to the second housing 220. For example, the first housing 210 may rotate with respect to the second housing 220 based on the first folding axis f1 through the first hinges 251 and 252. According to an embodiment, the first angle a1 between the second housing 220 and the first housing 210 may be positioned within a certain angle (e.g., approximately 0° to 180°) range through the rotation of the first housing 210. The certain angle is not limited to 0° to 180°, and the first housing 210 may rotate within a range in which the first hinges 251 and 252 supports with respect to the second housing 220. The second hinges 261 and 262 may be disposed between the second housing 220 and the third housing 230. The second hinges 261 and 262 may rotatably connect the third housing 230 with respect to the second housing 220. For example, the third housing 230 may rotate with respect to the second housing 220 based on the second folding axis f2 through the second hinges 261 and 262. According to an embodiment, the second angle a2 between the second housing 220 and the third housing 230 may be positioned within the certain angle (e.g., approximately 0° to) 180° range through the rotation of the third housing 230. The certain angle is not limited to 0° to 180°, and the third housing 230 may rotate within a range in which the second hinges 261 and 262 supports with respect to the second housing 220.

According to an embodiment, the first hinge structure 250 may include a first hinge cover 253. The second hinge structure 260 may include a second hinge cover 263. The first hinges 251 and 252 may be surrounded by the first hinge cover 253. One 251 of the first hinges 251 and 252 may be disposed in a partial area of the first hinge cover 253, and another 252 may be disposed in another partial area of the first hinge cover 253. The second hinges 261 and 262 may be surrounded by the second hinge cover 263. One 261 of the second hinges 261 and 262 may be disposed in a partial area of the second hinge cover 263, and another 262 may be disposed in another partial area of the second hinge cover 263.

According to an embodiment, the flexible display 240 may further include the fourth display area 244 and the fifth display area 245 that are at least partially flexibly bendable, so as to be rotated by (and together with) the first hinge structure 250 and/or the second hinge structure 260. The fourth display area 244 may be disposed on the first hinge cover 253. The fourth display area 244 may be coupled to the first hinge cover 253 or the first hinges 251 and 252. For example, the fourth display area 244 may be supported by a hinge plate (not illustrated) included in the first hinges 251 and 252. The fourth display area 244 may be deformed as the first housing 210 rotates with respect to the second housing 220 based on the first folding axis f1. That is, the fourth display area 244 may be deformed together with (or by) rotation of the first housing 210 with respect to the second housing 220. The fifth display area 245 may be disposed on the second hinge cover 263. The fifth display area 245 may be coupled to the second hinge cover 263 or the second hinges 261 and 262. For example, the fifth display area 245 may be supported by a hinge plate (not illustrated) included in the second hinges 261 and 262. The fifth display area 245 may be deformed as the third housing 230 rotates with respect to the second housing 220 based on the second folding axis f2. That is, the fifth display area 245 may be deformed together with (or by) rotation of the third housing 230 with respect to the second housing 220.

According to an embodiment, a first width w1 of the first hinge structure 250 may be narrower (or smaller) than a second width w2 of the second hinge structure 260. The width may be taken along an xy plane within the electronic device 101 which is unfolded. For example, the second width w2 may be wider (or larger) than the first width w1. As the second width w2 is wider than the first width w1, a space (or volume) by a difference between the second width w2 and the first width w1 may be formed in the second folded state in which the first housing 210 and the third housing 230 are folded with respect to the second housing 220. A structure in which the first housing 210 is disposed to accommodate at least a portion (e.g., the first lateral side 211 of the first housing 210) of the first housing 210 in the space may be formed.

An area of a deformable display area may correspond to an area of a respective hinge structure. For example, an area of the fifth display area 245 disposed on the second hinge structure 260 may be wider than an area of the fourth display area 244 disposed on the first hinge structure 250. For example, a width w2 of the fifth display area 245 may be wider than a width w1 of the fourth display area 244. For example, when the electronic device 101 is changed from the unfolded state to the plurality of folded states, a radius of curvature of the fifth display area 245 may be greater than a radius of curvature of the fourth display area 244. For example, since the first width w1 of the first hinge structure 250 is narrower than the second width w2 of the second hinge structure 260, the third housing 230 may be stacked on the first housing 210 while the electronic device 101 is changed from the unfolded state to the second folded state. The electronic device 101 may be referred to as the electronic device 101 having a G fold shape in the second folded state. For example, the second folded state of the electronic device 101 may be a state in which the third housing 230 covers the fourth surface 210b opposite to the first surface 210a of the first housing 210, as the third housing 230 is folded with respect to the second housing 220 after the first housing 210 is folded with respect to the second housing 220. The electronic device 101 may have a G shape when viewed from a lateral side (e.g., when viewed from a +y direction). However, it is not limited thereto.

According to an embodiment, a rotation radius of the first housing 210 with respect to the second housing 220 may be smaller than a rotation radius of the third housing 230 with respect to the second housing 220.

According to an embodiment, the electronic device 101 may further include first magnets 271 and 272 and second magnets 281 and 282 configured to magnetically interact with the first magnets 271 and 272. The first magnets 271 and 272 may be disposed in the first housing 210. The second magnets 281 and 282 may be disposed in the second housing 220. For example, the first magnets 271 and 272 may be disposed along the first lateral side 211 of the first housing 210. For example, compared to a lateral side of the first housing 210 facing the first hinge structure 250, the first magnets 271 and 272 may be disposed closer to another lateral side facing the lateral side. When the flexible display 240 is viewed from above, the first magnets 271 and 272 may at least partially overlap an inactive area (like a non-display aera) disposed along a periphery of the first display area 241. The first magnets 271 and 272 may be disposed to face the second magnets 281 and 282 when the first housing 210 is rotated and folded with respect to the second housing 220 along the first folding axis f1. For example, the second magnets 281 and 282 may be disposed along the second hinge structure 260. For example, when referring to FIGS. 2A and 2B, the second magnets 281 and 282 may be configured to maintain the first folded state of the electronic device 101 through a magnetic force with the first magnets 271 and 272. According to an embodiment, at least a portion of the first display area 241 may be fastened to at least a portion of the second display area 242 through the magnetic force. The rotation of the first housing 210 with respect to the second housing 220 in the first folded state may be limited by the magnetic force such that rotation of the first housing 210 in a direction away from the second housing 220 is limited by the magnetic force of respective first and second magnets facing each other.

According to an embodiment, the first lateral side 211 among the first set of lateral sides 201 of the first housing 210 may be configured to face at least a portion of the flexible display 240 in the plurality of folded states of the electronic device 101. For example, when referring to FIGS. 2B and 2C, the first lateral side 211 may face the at least a portion of the flexible display 240 while the electronic device 101 is changed from the first folded state to the second folded state among the plurality of folded states. The first lateral side 211 may face at least the part of the third display area 243 and/or at least a portion of the fifth display area 245 on the second hinge structure 260, while the electronic device 101 is changed from the first folded state to the second folded state or the electronic device 101 is changed from the second folded state to the first folded state. For example, when referring to FIG. 2C, the first lateral side 211 may face at least a portion of the fifth display area 245 of the flexible display 240 in the second folded state of the electronic device 101. For example, the first lateral side 211 may be surrounded by at least a portion of the flexible display 240 in the second folded state. For example, the first lateral side 211 may be a lateral side facing the flexible display 240 among the first set of lateral sides 201, the second set of lateral sides 202, and the third set of lateral sides 203 in the second folded state.

Referring to FIGS. 2A and 2B, the first housing 210 may rotate with respect to the second housing 220 based on the first folding axis f1 through the first hinge structure 250 while changing from the unfolded state to the first folded state. According to an embodiment, in the first folded state, the first housing 210 may face the second housing 220. For example, in the first folded state, the second display area 242 disposed in the second housing 220 may face the first display area 241 disposed in the first housing 210. According to an embodiment, in the first folded state, the first housing 210 may be disposed above the second housing 220 to be stacked based on the +y direction.

Referring to FIGS. 2B and 2C, the third housing 230 may rotate with respect to the second housing 220 based on the second folding axis f2 through the second hinge structure 260. In the second folded state, the third housing 230 may face the first housing 210. For example, in the second folded state, the third display area 243 disposed in the third housing 230 may face the fourth surface 210b opposite to the first surface 210a of the first housing 210. The first lateral side 211 of the first housing 210 may face the fifth display area 245. According to an embodiment, in the second folded state of the electronic device 101, when the electronic device 101 is viewed from a lateral side (e.g., when viewed in the +y direction), the first housing 210 may be dispose to be stacked over the second housing 220 and the third housing 230 may be disposed to be stacked over the first housing 210, based on the +z direction. For example, in the second folded state, the first housing 210 may be disposed on the second housing 220. In the second folded state, the third housing 230 may be disposed on the first housing 210.

According to an embodiment, in the second folded state, an overlapping area between the flexible display 240 and the second hinge structure 260 when the second hinge cover 263 is viewed from above, may be wider than an overlapping area between the flexible display 240 and the first hinge structure 250 when the first hinge cover 253 is viewed from above. The second width w2 of the second hinge cover 263 corresponding to the fifth display area 245 may be wider than the first width w1 of the first hinge cover 253 corresponding to the fourth display area 244 (e.g., the fourth display area 244 of FIG. 2A).

A difference between the first width w1 and the second width w2 may correspond to a thickness of the third housing 230. According to an embodiment, when a portion (e.g., the first lateral side 211) of the first housing 210 is disposed to face the fifth display area 245 in the second folded state, the second width w2 may be formed as large as a size to be accommodated in a portion of a space formed when the third housing 230 is stacked on the first housing 210.

According to an embodiment, based on the difference between the first width w1 and the second width w2, a housing which is foldable first among the third housing 230 and the first housing 210 may be determined. For example, relative to an unfolded state (FIG. 2A), the first housing 210 may first rotate with respect to the second housing 220 based on the first folding axis f1 (FIG. 2B). After the first housing 210 is folded (FIG. 2B), the third housing 230 may rotate with respect to the second housing 220 based on the second folding axis f2 (FIG. 2C). As the width w1 of the first hinge structure 250 is narrower than the width w2 of the second hinge structure 260, the first housing 210 may be folded to face the second housing 220 first, such as from an unfolded state. As the width w2 of the second hinge structure 260 is wider than the width w1 of the first hinge structure 250, the third housing 230 may be folded to face the fourth surface 210b of the first housing 210 after the first housing 210 is folded.

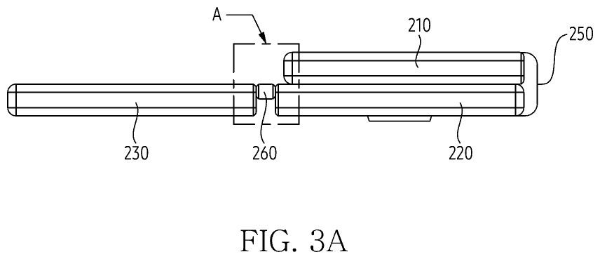

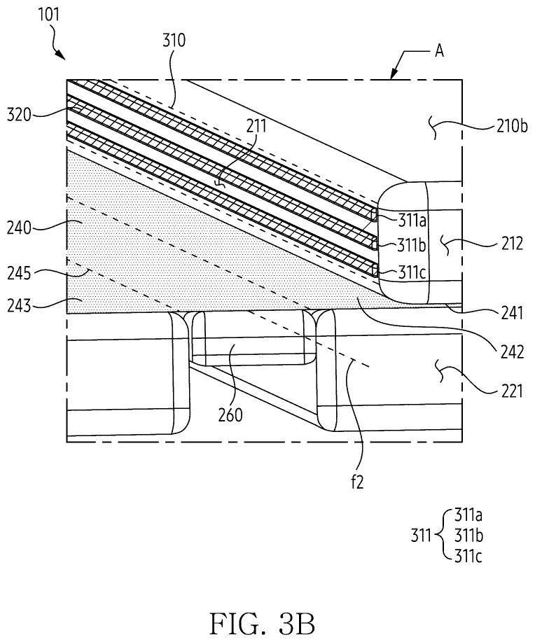

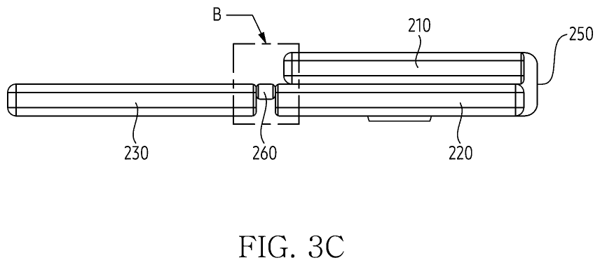

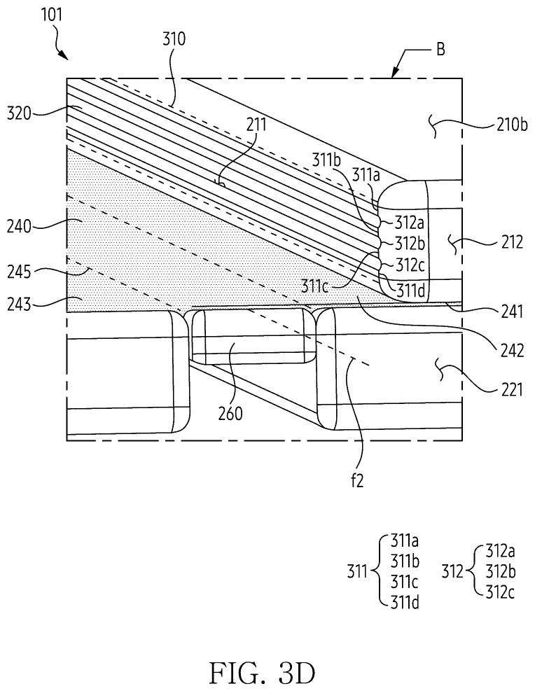

According to an embodiment, the first set of lateral sides 201 may include the second lateral side 212 in contact with the first lateral side 211 such as meeting at a corner, and a third lateral side 213 facing the second lateral side 212 and meeting the first lateral side 211. A length d2 of the second lateral side 212 and a length d3 of the third lateral side 213 may be shorter than a length d1 of the first lateral side 211, respectively. For example, the first lateral side 211 may have a length corresponding to a major axis (or major planar dimension) of the first housing 210. The second lateral side 212 and/or the third lateral side 213, in contact with the first lateral side 211 may have a length corresponding to a short axis (or minor planar dimension) of the first housing 210. For example, when referring to FIGS. 2A and 2B, at least a portion of the first set of lateral sides 201 may be a side which is gripped by a part (e.g., a finger) of a body of the user while the electronic device 101 is changed from the first folded state to the unfolded state. In a case that the first lateral side 211 is a side which is gripped, since the length d1 of the first lateral side 211 is greater than the length d2 of the second lateral side 212 and the length d3 of the third lateral side 213, it may not be easy to rotate the first housing 210 with respect to the second housing 220 due to a magnetic force between the first magnets 271 and 272 and the second magnets 281 and 282 in the first folded state. For example, in a case that the first lateral side 211 is flat, a frictional force between the first lateral side 211 and the finger of the user may be relatively small. Since the frictional force between the first lateral side 211 and the finger of the user is relatively small, it may not be easy to rotate the first housing 210 with respect to the second housing 220. In order to easily change from the first folded state to the unfolded state by the user, the electronic device 101 may require a structure for guiding (or providing) a state change of the electronic device 101 by the user to the first set of lateral sides 201 including the first lateral side 211. The structure for guiding the state change of the electronic device 101 will be described later in FIG. 3A.

According to the above-described embodiment, the electronic device 101 may provide the flexible display 240 which may be folded at least once by including the plurality of hinge structures 250 and 260. The flexible display 240 may be folded multiple times through different widths of the hinge structures 250 and 260.

FIGS. 3A and 3B illustrate a side view and an enlarged perspective view of a portion of an electronic device in a first folded state according to an embodiment. FIGS. 3C and 3D illustrate a side view and an enlarged perspective view of a portion of an electronic device in a first folded state according to an embodiment. FIGS. 3B and 3D are enlarged perspective views of region A and region B of FIGS. 3A and 3C, respectively.

Referring to FIGS. 3A to 3D, an electronic device 101 may include a first housing 210 including a first surface (the first surface 210a of FIG. 2A) and a first set of lateral sides (e.g., the first set of lateral sides 201 of FIG. 2A) extending from the first surface 210a, a second housing 220 including a second surface 220a, a third housing 230 including a third surface 230a, and a flexible display 240 disposed on the first surface 210a, the second surface 220a, and the third surface 230a. According to an embodiment, the electronic device 101 may include a first hinge structure (the first hinge structure 250 of FIG. 2A), disposed between the first housing 210 and the second housing 220 and rotatably connecting the first housing 210 and the second housing 220, and a second hinge structure 260, disposed between the second housing 220 and the third housing 230 and rotatably connecting the second housing 220 and the third housing 230. The first hinge structure 250 and the second hinge structure 260 may be configured to provide an unfolded state in which the first surface 210a, the second surface 220a, and the third surface 230a face the same direction, and a plurality of folded states in which at least one of the first surface 210a, the second surface 220a, and the third surface 230a faces a different direction. The first set of lateral sides 201 may include a first lateral side 211 configured to face at least a portion of the flexible display 240 in the plurality of folded states.

Hereinafter, an overlapping description of the configuration described in FIG. 2A, FIG. 2B, and FIG. 2C will be omitted.

According to an embodiment, the first lateral side 211 may include a pattern 310 including a plurality of protrusions 311. For example, the pattern 310 may form at least a portion of the first lateral side 211. For example, the pattern 310 may be disposed on the first lateral side 211. For example, the plurality of protrusions 311 may be spaced apart from each other. For example, the plurality of protrusions 311 may include a first protrusion 311a, a second protrusion 311b, and a third protrusion 311c protruding from the first lateral side 211. According to an embodiment, the first protrusion 311a, the second protrusion 311b, and the third protrusion 311c may be spaced apart from each other at a specified interval along the first lateral side 211, respectively. The first lateral side 211 may increase a contact area for deforming the flexible display 240 by a user, by including the pattern 310 including the plurality of protrusions 311. The first lateral side 211 may be configured to guide a state change of the electronic device 101 by the user while the electronic device 101 is changed from the first folded state (FIG. 2B) to the unfolded state (FIG. 2) by increasing the contact area at which an external tool (like a hand, finger, etc. of a body) may contact or apply a force to the electronic device 101 for rotating the first housing 210 in a direction away from the second housing 220.

According to an embodiment, the first housing 210 may further include an elastic member 320 which may form and the plurality of protrusions 311 of the pattern 310. The plurality of protrusions 311 being or having the elastic member 320 may be deformable relative to the first lateral side 211. For example, the elastic member 320 may be attached on the first lateral side 211, such as to form a protrusion. For example, the clastic member 320 may protrude from the first lateral side 211. For example, while the electronic device 101 is changed from the first folded state to a second folded state, a fifth display area 245 on the second hinge structure 260 may face the first lateral side 211. In the second folded state, the fifth display area 245 may be in contact with the plurality of protrusions 311 in the pattern 310 by facing the first lateral side 211. The plurality of protrusions 311 may be formed of the deformable clastic member 320, thereby supporting the fifth display area 245 in contact with the plurality of protrusions 311 in the second folded state and reducing damage to the fifth display area 245. As being in contact, elements may form an interface (e.g., a physical interface) therebetween.

According to an embodiment, the pattern 310 of the first lateral side 211 may further include a plurality of grooves 312 formed between the plurality of protrusions 311. For example, the plurality of protrusions 311 may be formed by the plurality of grooves 312 formed at the first lateral side 211. For example, protrusions 312a, 312b, 312c, and 312d may be formed by grooves 312a, 312b, and 312c between the protrusions. For example, the pattern 310 may have a wave shape formed by the plurality of protrusions 311 and the plurality of grooves 312 between the plurality of protrusions 311. For example, the pattern 310 may include a plurality of crests formed by the plurality of protrusions 311 and a plurality of valleys formed by the plurality of grooves 312. For example, the plurality of protrusions 311 and the plurality of grooves 312 between the plurality of protrusions 311 may extend along a longitudinal direction of the first lateral side 211. A body of the first lateral side 211 may include (or define) the pattern 310 including the plurality of protrusions 311 and the plurality of grooves 312 between the plurality of protrusions 311, thereby increasing the contact area for deforming the flexible display 240 by the user. The first lateral side 211 may be configured to guide a state change of the electronic device 101 by the user while the electronic device 101 is changed from the first folded state to the unfolded state by increasing the contact area. For example, a frictional force between the first lateral side 211 and a finger of the user may increase since it is possible to increase the contact area for deforming the flexible display 240 by the user as the first lateral side 211 includes the pattern 310 including the plurality of protrusions 311 and the plurality of grooves 312 between the plurality of protrusions 311. Since the frictional force between the first lateral side 211 and the finger of the user increases, the electronic device 101 may be configured to provide a state change of the electronic device 101 by the user while the electronic device 101 is changed from the first folded state to the unfolded state.

It has been described that the first lateral side 211 includes the pattern 310, but it is not limited thereto. The first housing 210 may include the pattern 310 including the plurality of protrusions 311 and/or the plurality of grooves for increasing a contact area on the second lateral side 212 and/or the third lateral side 213, in contact with the first lateral side 211. The first housing 210 may be configured to guide a state change of the electronic device 101 by the user while the electronic device 101 is changed from the first folded state to the unfolded state, by including the pattern 310.

It has been described that the pattern 310 includes the plurality of protrusions 311 and/or the plurality of grooves 312, but it is not limited thereto. The pattern 310 may include various patterns for increasing an area of at least a portion of the first set of lateral sides 201 in which the pattern 310 is disposed. For example, the pattern 310 may have an irregular shape. The pattern 310 may be configured to guide a state change of the electronic device 101 by the user while the electronic device 101 is changed from the first folded state to the unfolded state by increasing the area of the at least a portion of the first set of lateral sides 201. In addition, according to an embodiment, it has been described that the pattern 310 includes the plurality of protrusions 311 and/or the plurality of grooves 312, but it is not limited thereto. For example, the first set of lateral sides 201 may be substituted with various materials (e.g., rubber with elasticity, and the like) to increase a grip force between a part (e.g., the finger) of the body of the user and the pattern 310, so that the user may easily change the electronic device 101 from the plurality of folded states to the unfolded state. For example, the first set of lateral sides 201 may be substituted with various materials to increase a frictional force between a part of the body of the user and the pattern 310, so that the user may easily change the electronic device 101 from the plurality of folded states to the unfolded state.

According to the above-described embodiment, the electronic device 101 may increase the contact area for deforming the flexible display 240 by including the pattern 310 formed at the first lateral side 211 of the first housing 210. The first lateral side 211 may be configured to guide a state change of the electronic device 101 by the user while the electronic device 101 is changed from the first folded state to the unfolded state by increasing the contact area.

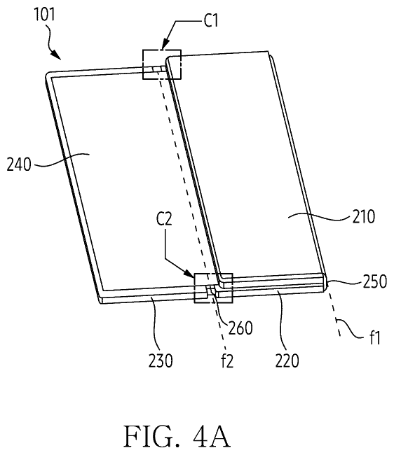

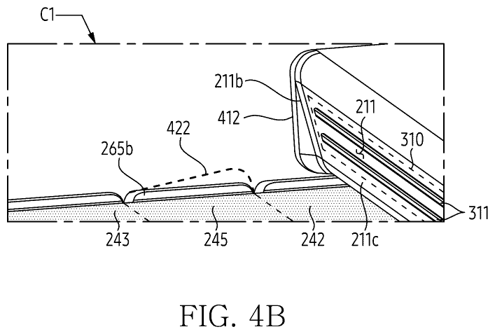

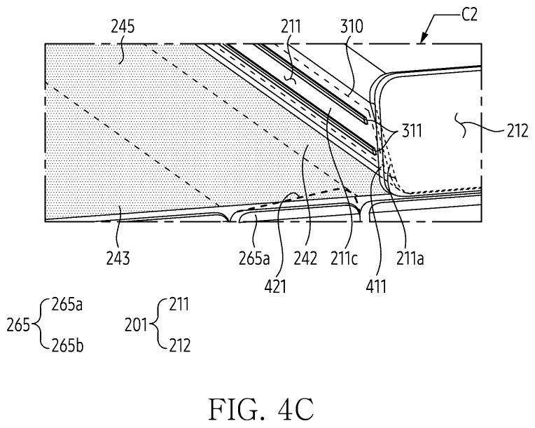

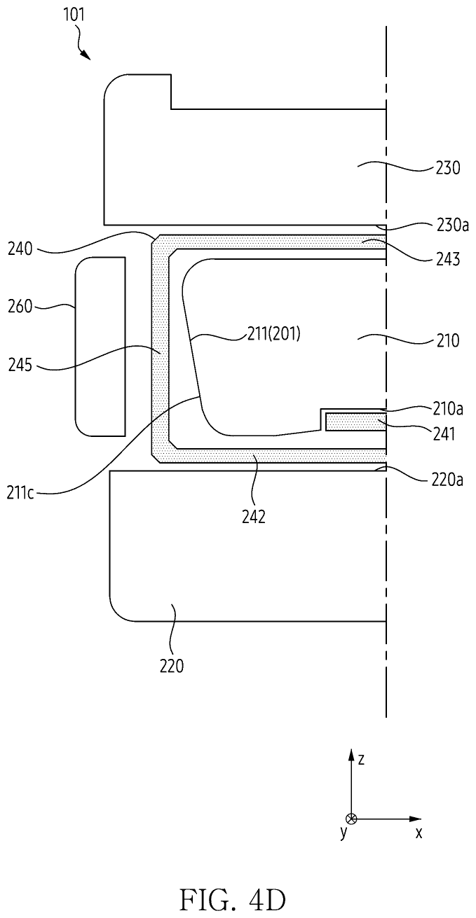

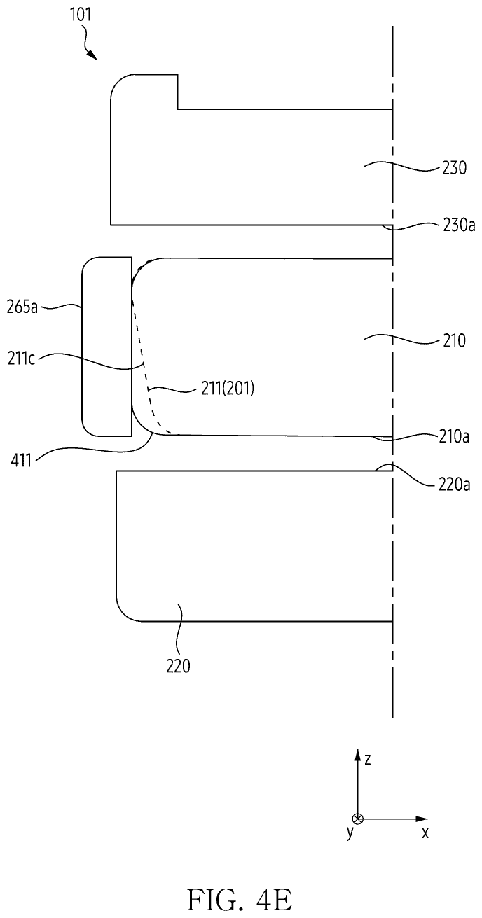

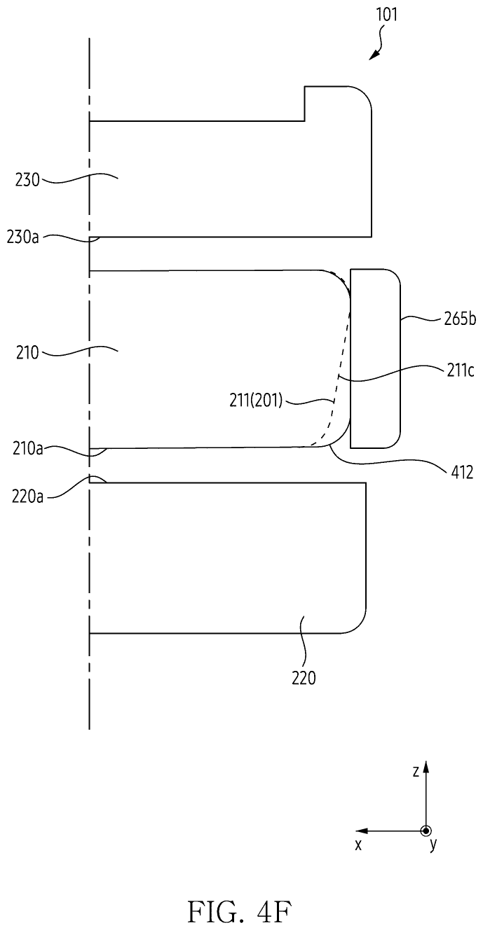

FIG. 4A illustrates a perspective view of an electronic device in a first folded state according to an embodiment. FIGS. 4B and 4C illustrate enlarged perspective views of portions of the electronic device of FIG. 4A. FIGS. 4B and 4C are enlarged perspective views of regions C1 and C2 of FIG. 4A, respectively.

FIG. 4D is a partial cross-sectional view of an electronic device in a second folded state cut along line A-A′ of FIG. 2C. FIG. 4E is a partial cross-sectional view of an electronic device in a second folded state cut along line B-B′ of FIG. 2C. FIG. 4F is a partial cross-sectional view of an electronic device in a second folded state cut along line C-C′ of FIG. 2C.

Referring to FIGS. 4A through 4F, an electronic device 101 may include a first housing 210 including a first surface 210a and a first set of lateral sides (e.g., the first set of lateral sides 201 of FIG. 2A) extending from the first surface 210a, a second housing 220 including a second surface 220a, a third housing 230 including a third surface 230a, and a flexible display 240 disposed on the first surface 210a, the second surface 220a, and the third surface 230a. According to an embodiment, the electronic device 101 may include a first hinge structure 250, disposed between the first housing 210 and the second housing 220 and rotatably connecting the first housing 210 and the second housing 220, and a second hinge structure 260, disposed between the second housing 220 and the third housing 230 and rotatably connecting the second housing 220 and the third housing 230. The first hinge structure 250 and the second hinge structure 260 may be configured to provide an unfolded state in which the first surface 210a, the second surface 220a, and the third surface 230a face the same direction, and a plurality of folded states in which at least one of the first surface 210a, the second surface 220a, and the third surface 230a faces a different direction. According to an embodiment, the first set of lateral sides 201 may include a first lateral side 211, including a pattern 310 including a plurality of protrusions 311, and configured to face at least a portion of the flexible display 240 in the plurality of folded states.

According to an embodiment, the first housing 210 may further include a first rib 411 protruding from an end 211a of the first lateral side 211 and/or a second rib 412 protruding from another end 211b opposite to the end 211a of the first lateral side 211. According to an embodiment, the first rib 411 and/or the second rib 412 may be configured to separate the flexible display 240 from the first lateral side 211 in the plurality of folded states by contacting the second hinge structure 260. In an embodiment the lateral sides (like 212 and 213) of the first housing 210 may protrude further than first lateral side 211 to define the ribs.

For example, the end 211a of the first lateral side 211 may be a portion in which the first lateral side 211 and the second lateral side 212 are in contact with each other. The other end 211b opposite to the end 211a of the first lateral side 211 may be a portion in which the first lateral side 211 is in contact with a third lateral side (e.g., the third lateral side 213 of FIG. 2A) opposite to and the second lateral side 212. For example, a fifth display area 245 of the flexible display 240 may be disposed on the second hinge structure 260. Both ends of the hinge structure 260 may be configured to face both ends 211a and 211b of the first lateral side 211 while the electronic device 101 is changed from the first folded state to the second folded state. For example, the first rib 411 may extend from the end 211a of the first lateral side 211. The second rib 412 may extend from the other end 211b opposite to the end 211a of the first lateral side 211. Since the first rib 411 and the second rib 412 respectively protrude further than the first lateral side 211, the first rib 411 may face the second rib 412 when viewed from above. For example, while changing from the first folded state to the second folded state, an end of the second hinge structure 260 may be contact with the first rib 411. Another end of the second hinge structure 260 opposite to the end may be in contact with the second rib 412. In the second folded state, the first rib 411 and the second rib 412 may support the second hinge structure 260. Since the first rib 411 and the second rib 412 support the second hinge structure 260, the fifth display area 245 on the second hinge structure 260 may be spaced apart from the first lateral side 211. The first housing 210 may include the first rib 411 and the second rib 412, thereby reducing damage to the fifth display area 245 which is bent while changing from the first folded state to the second folded state.

According to an embodiment, the first lateral side 211 may further include an inclined surface 211c having an incline with respect to the first surface 210a. For example, the inclined surface 211c may be a portion of the first lateral side 211 which is inclined to have an obtuse angle with respect to the first surface 210a. For example, the inclined surface 211c may be a portion of the first lateral side 211 which is inclined to have an acute angle with respect to a fourth surface 210b opposite the first surface 210a. The first lateral side 211 may be configured to guide a state change of the electronic device 101 by a user while the electronic device 101 is changed from the first folded state to the unfolded state, by including the inclined surface 211c.

It has been described that the first lateral side 211 has the inclined surface 211c, but it is not limited thereto. The first housing 210 may be inclined to have the obtuse angle with respect to the first surface 210a and may include a plurality of inclined surfaces formed at at least a portion of the first set of lateral sides 201. The first housing 210 may be configured to assist a state change of the electronic device 101 by the user while the electronic device 101 is changed from the first folded state to the unfolded state, by including the inclined surfaces. In an embodiment, the ribs may meet the first lateral side 211 at the rear side of the housing and may extend further from the first lateral side 211 at a front side of the housing.

According to an embodiment, the second hinge structure 260 may include a support portion 265 exposed to the outside of the electronic device 101 and configured to face the first lateral side 211 in the plurality of folded states of the electronic device 101. The support portion 265 may be spaced apart from the first lateral side 211 in the first folded state among the plurality of folded states. The support portion 265 may be in contact with the first lateral side 211 in the second folded state among the plurality of folded states. For example, the support portion 265 may be a portion of a second hinge cover (e.g., the second hinge cover 263 of FIG. 2A) of the second hinge structure 260. For example, the support portion 265 may be in contact with both ends of the fifth display area 245 of the flexible display 240. For example, the support portion 265 may include a first support portion 265a formed at an end of the hinge structure 260, and a second support portion 265b formed at another end opposite the end of the hinge structure 260. According to an embodiment, the first support portion 265a may be configured to be in contact with the end 211a of the first lateral side 211 in the second folded state of the electronic device 101. According to an embodiment, the second support portion 265b may be configured to be in contact with the other end 211b of the first lateral side 211 in the second folded state. The second hinge structure 260 may reduce damage to the fifth display area 245 on the second hinge structure 260 which is bent while changing from the first folded state to the second folded state, by including the support portion 265.

According to an embodiment, the second hinge structure 260 may include a third rib 421 as a first hinge rib configured to be in contact with the end 211a of the first lateral side 211, and a fourth rib 422 as a second hinge rib configured to be in contact with the other end 211b opposite to the end 211a of the first lateral side 211. The dotted lines for the third rib 421 and the fourth rib 422 indicate a shape of the ribs relative to the support portion 265. For example, the third rib 421 may protrude from the first support portion 265a of the second hinge structure 260. The fourth rib 422 may protrude from the second support portion 265b facing the first support portion 265a of the second hinge structure 260. The third rib 421 and the fourth rib 422 may be configured to be in contact with both ends 211a and 211b of the first housing 210 at the first lateral side 211 while the electronic device 101 is changed from the first folded state to the second folded state. For example, in the second folded state, the third rib 421 may support the end 211a of the first lateral side 211. In the second folded state, the fourth rib 422 may support the other end 211b of the first lateral side 211. For example, in a case that the first housing 210 includes the first rib 411 and the second rib 412, the third rib 421 may overlap the first rib 411 in the second folded state, such as overlapping along a thickness direction of the folded electronic device. The fourth rib 422 may overlap the second rib 412 in the second folded state. That is, the overlapping ribs may be arranged facing each other along the z direction. For example, in a case that the first lateral side 211 has the inclined surface 211c, each of the third rib 421 and the fourth rib 422 may have inclined surfaces having an angle corresponding to the inclined surface 211c. The second hinge structure 260 may include the third rib 421 and the fourth rib 422, thereby reducing damage to the fifth display area 245 on the second hinge structure 260 which is bent while changing from the first folded state to the second folded state.

According to the above-described embodiment, the electronic device 101 may be configured to guide a state change of the electronic device 101 by the user while the electronic device 101 is changed from the first folded state to the unfolded state by including the inclined surface 211c formed at the first lateral side 211 of the first housing 210. The electronic device 101 may include the ribs 411, 412, 421, and 422, thereby reducing damage to the flexible display 240 which is deformed while the electronic device 101 is changed from the first folded state to the second folded state.

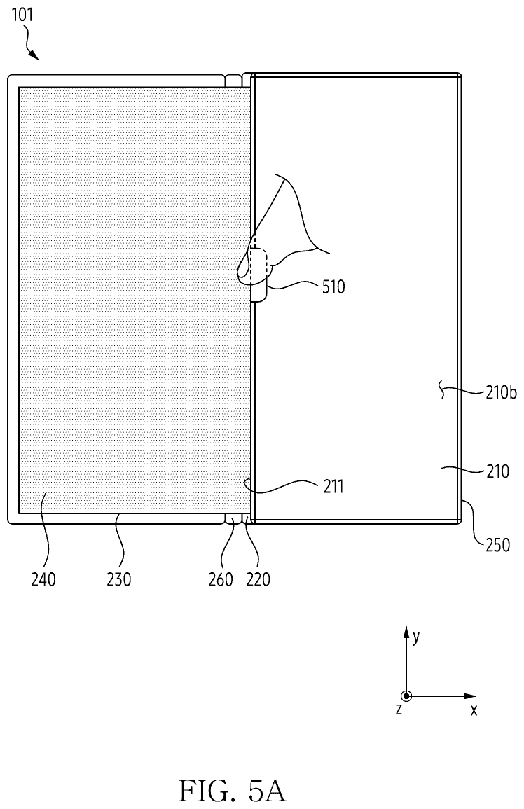

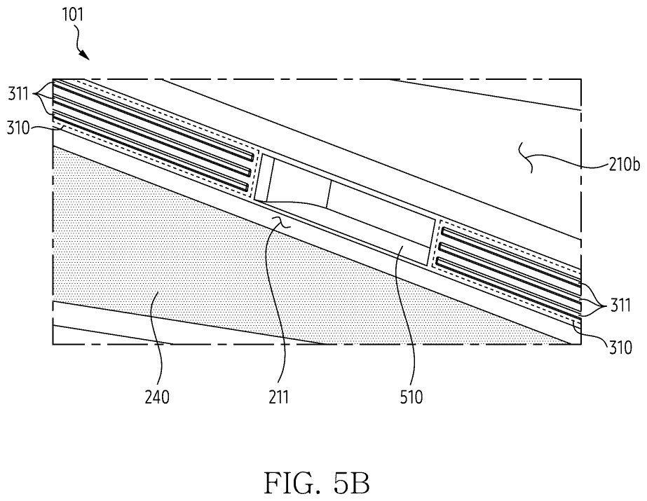

FIG. 5A is a top plan view of an electronic device in a first folded state. FIG. 5B illustrates an enlarged perspective view of a portion of an electronic device.

Referring to FIGS. 5A and 5B, an electronic device 101 may include a first housing 210 including a first surface (e.g., the first surface 210a of FIG. 2A) and a first set of lateral sides (e.g., the first set of lateral sides 201 of FIG. 2A) extending from the first surface 210a, a second housing 220 including a second surface (e.g., the second surface 220a of FIG. 2A), a third housing 230 including a third surface (e.g., the third surface 230a of FIG. 2A), and a flexible display 240 disposed on the first surface 210a, the second surface 220a, and the third surface 230a. According to an embodiment, the electronic device 101 may include a first hinge structure 250, disposed between the first housing 210 and the second housing 220 and rotatably connecting the first housing 210 and the second housing 220, and a second hinge structure 260, disposed between the second housing 220 and the third housing 230 and rotatably connecting the second housing 220 and the third housing 230. According to an embodiment, the first hinge structure 250 and the second hinge structure 260 may be configured to provide an unfolded state in which the first surface 210a, the second surface 220a, and the third surface 230a face the same direction, and a plurality of folded states in which at least one of the first surface 210a, the second surface 220a, and the third surface 230a faces a different direction. According to an embodiment, the first set of lateral sides 201 may include a first lateral side 211, including a pattern 310 including a plurality of protrusions 311, and configured to face at least a portion of the flexible display 240 in the plurality of folded states.

According to an embodiment, the first housing 210 may further include a first groove 510 formed at the first lateral side 211. For example, the first groove 510 may be dent from the first lateral side 211 toward an inner space of the first housing 210. For example, the first groove 510 may be disposed between groups of the patterns 310 formed at the first lateral side 211. For example, the first groove 510 may be disposed between the first surface 210a and a fourth surface 210b opposite the first surface 210a. According to an embodiment, the pattern 310 including the plurality of protrusions 311 may be omitted completely or in part. For example, in a case that the pattern 310 is not formed on the first lateral side 211, only the first groove 510 may be formed at the first lateral side 211. However, it is not limited thereto.

Referring to FIG. 5A, according to an embodiment, the first groove 510 may be formed at at least a portion of the fourth surface 210b of the first housing 210 and at least a portion of the first lateral side 211. A body of the first housing 210 may have the first groove 510 defined therein. According to an embodiment, the first groove 510 may be opened toward the fourth surface 210b and towards the first lateral side 211. For example, since the first groove 510 is formed at the at least a portion of the fourth surface 210b, the first housing 210 may be configured to guide a state change of the electronic device 101 by a user while the electronic device 101 is changed from the first folded state to the unfolded state.

Referring to FIG. 5B, according to an embodiment, the first groove 510 may be disposed between the first surface (e.g., the first surface 210a of FIG. 2A) and the fourth surface 210b opposite to the first surface 210a. The first groove 510 may be open only at the first lateral side 211, as a recess defined in the body of the first housing 210. As the first groove 510 is disposed between the first surface 210a and the fourth surface 210b, a portion (e.g., a finger) of a body of the user may be closer inside the first groove 510. The first groove 510 may be configured to guide a state change of the electronic device 101 by the user while the electronic device 101 is changed from the first folded state to the unfolded state, by being disposed between the first surface 210a and the fourth surface 210b. Here, the first groove 510 increases the contact area at which an external tool (like a hand, finger, etc. of a body) may contact or apply a force to the electronic device 101 for rotating the first housing 210 in a direction away from the second housing 220.

It has been described that the electronic device 101 includes the first groove 510 formed at the first lateral side 211, but it is not limited thereto. The electronic device 101 may include a plurality of grooves formed at the first lateral side 211 to guide a state change of the electronic device 101 by the user while the electronic device 101 is changed from the first folded state to the unfolded state.

According to the above-described embodiment, the electronic device 101 may be configured to guide a state change of the electronic device 101 by the user while the electronic device 101 is changed from the first folded state to the unfolded state by including the first groove 510 formed at the first lateral side 211.

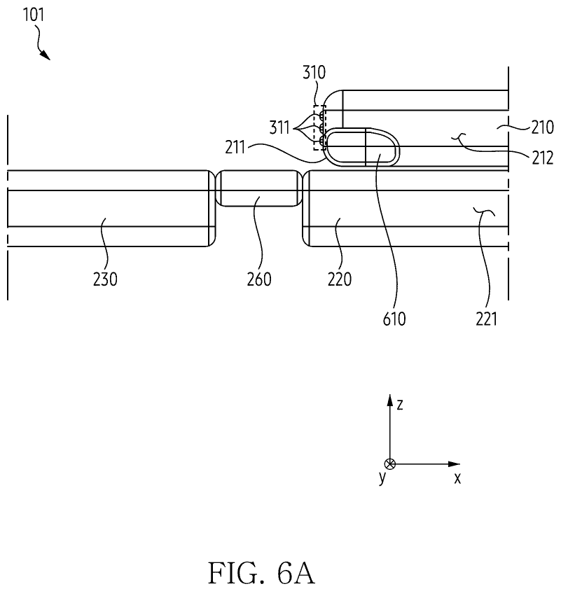

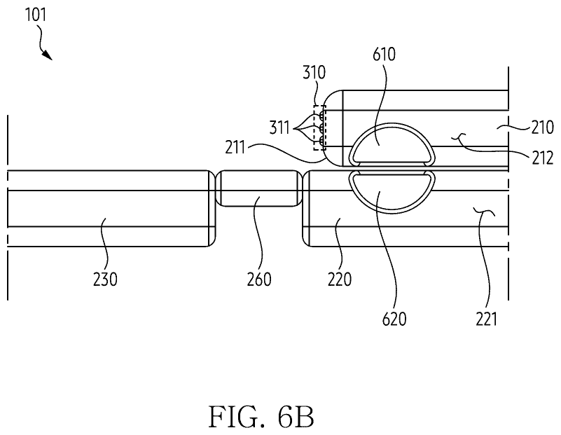

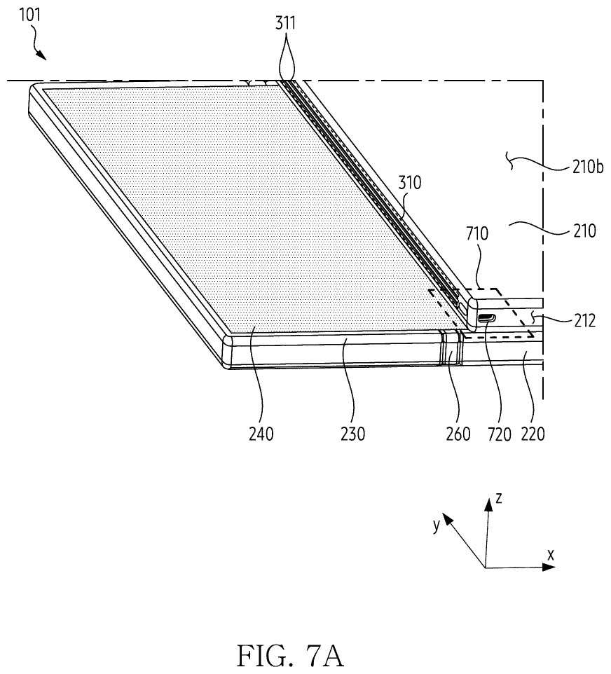

FIGS. 6A and 6B illustrate side views a portion of an electronic device in a first folded state according to embodiments.

Referring to FIGS. 6A and 6B, an electronic device 101 may include a first housing 210 including a first surface (e.g., the first surface 210a of FIG. 2A) and a first set of lateral sides (e.g., the first set of lateral sides 201 of FIG. 2A) extending from the first surface 210a, a second housing 220 including a second surface (e.g., the second surface 220a of FIG. 2A), a third housing 230 including a third surface (e.g., the third surface 230a of FIG. 2A), and a flexible display (e.g., the flexible display 240 of FIG. 2A) disposed on the first surface 210a, the second surface 220a, and the third surface 230a. The electronic device 101 may include a first hinge structure (e.g., the first hinge structure 250 of FIG. 2A), disposed between the first housing 210 and the second housing 220 and rotatably connecting the first housing 210 and the second housing 220, and a second hinge structure 260, disposed between the second housing 220 and the third housing 230 and rotatably connecting the second housing 220 and the third housing 230. According to an embodiment, the first hinge structure 250 and the second hinge structure 260 may be configured to provide an unfolded state in which the first surface 210a, the second surface 220a, and the third surface 230a face the same direction, and a plurality of folded states in which at least one of the first surface 210a, the second surface 220a, and the third surface 230a faces a different direction. According to an embodiment, the first set of lateral sides 201 may include a first lateral side 211, including a pattern 310 including a plurality of protrusions 311, and configured to face at least a portion of the flexible display 240 in the plurality of folded states.

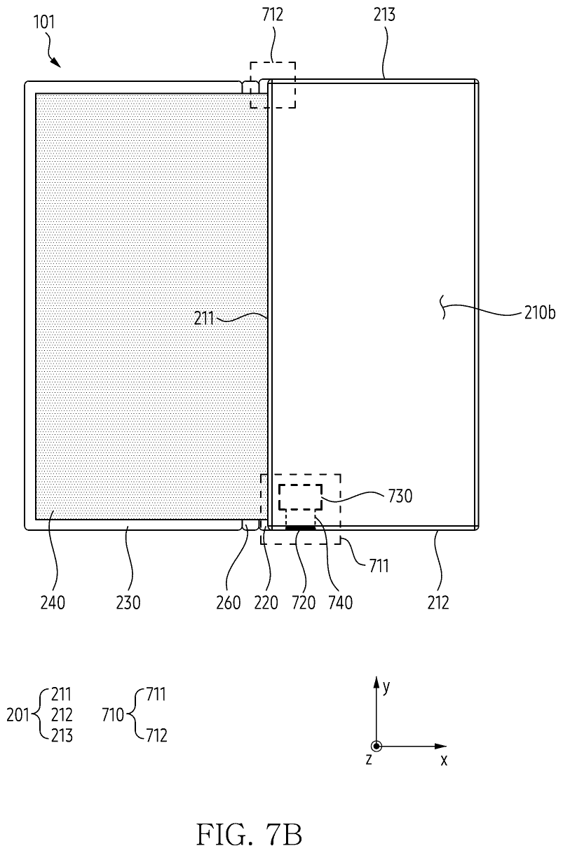

According to an embodiment, the first set of lateral sides 201 may include a second lateral side 212 in contact with the first lateral side 211, such as meeting at an end of the first housing 210. The first housing 210 may further include a second groove 610 formed recessed at the second lateral side 212. For example, the second groove 610 may be dent from the second lateral side 212 toward an inner space of the first housing 210. The second groove 610 may be open to outside the first housing 210 along the y direction. For example, at least a portion of the second groove 610 may face the flexible display 240 in the first folded state. For example, the second groove 610 may be formed at a portion (e.g., a first edge region 711 of FIG. 7B) of the first housing 210 where the first lateral side 211 and the second lateral side 212 are in contact with each other. The first housing 210 may be configured to guide a state change of the electronic device 101 by a user while the electronic device 101 is changed from the first folded state to the unfolded state, by including the second groove 610.

According to an embodiment, in the unfolded state, the second housing 220 may further include a fourth lateral side 221 facing the same direction as a direction in which the second lateral side 212 faces, and a third groove 620 formed at the fourth lateral side 221 and disposed to face at least a portion of the second groove 610. The third groove 620 may be open to outside the second housing 220 along the y direction. For example, the second groove 610 may be paired with the third groove 620 and arranged along a line extending in the z direction. The grooves may be formed in a pair of shapes similar in size and shape. For example, when referring to FIG. 6B, a direction in which the fourth lateral side 221 faces may be substantially the same as a direction in which the second lateral side 212 faces in the unfolded state and the plurality of folded states of the electronic device 101. For example, the direction in which the fourth lateral side 221 faces and the direction in which the second lateral side 212 faces may be parallel to a direction in which a first folding axis (e.g., the first folding axis f1 of FIG. 2A) faces. For example, the second lateral side 212 may be positioned on the fourth lateral side 221 in the first folded state.

For example, the third groove 620 may face the second groove 610 in the first folded state, along the thickness direction. For example, the third groove 620 may be dent from the fourth lateral side 221 toward an inner space of the second housing 220. The third groove 620 may be open to outside the second housing 220 along the y direction. For example, each of the second groove 610 and the third groove 620 may have a hemispherical shape along the xz plane. In the first folded state, the second groove 610 and the third groove 620 may have a spherical shape, thereby forming a structure in which a part (e.g., a finger) of a body of the user is easily inserted into the second groove 610 and the third groove 620. However, it is not limited thereto, and the second lateral side 212 and the fourth lateral side 221 may be configured to guide a state change of the electronic device 101 by a user while the electronic device 101 is changed from the first folded state to the unfolded state by including paired grooves. Here, the second groove 610 and/or the third groove 620 increases the contact area at which an external tool (like a hand, finger, etc. of a body) may contact or apply a force to the electronic device 101 for rotating the first housing 210 in a direction away from the second housing 220.

According to an embodiment, it has been described that the second lateral side 212 and the fourth lateral side 221 include the second groove 610 and the third groove 620, respectively, but it is not limited thereto. The electronic device 101 may include a plurality of grooves formed at the third lateral side (e.g., the third lateral side 213 of FIG. 2A) facing the second lateral side 212 and/or a fifth lateral side (e.g., the fifth lateral side 222 of FIG. 2A) facing the fourth lateral side 221. The electronic device 101 may be configured to guide a state change of the electronic device 101 by the user while the electronic device 101 is changed from the first folded state to the unfolded state, by including the plurality of grooves formed at at least a portion of the second lateral side 212, the third lateral side 213, the fourth lateral side 221, and the fifth lateral side 222.

According to the above-described embodiment, the electronic device 101 may be configured to guide a state change of the electronic device 101 by the user while the electronic device 101 is changed from the first folded state to the unfolded state, by including the second groove 610 and/or the third groove 620 formed at the second lateral side 212 and/or the fourth lateral side 221, respectively. The shapes of the second groove 610 and/or the third groove 620 formed at the second lateral side 212 and the fourth lateral side 221, respectively, are not limited to an embodiment, and may have various shapes for assisting a grip of the user, so that the user easily changes the electronic device 101 from the plurality of folded states to the unfolded state. For example, the second groove 610 and/or the third groove 620 may be omitted. In a case that a pattern (e.g., the pattern 310 of FIG. 3A) including a plurality of protrusions (e.g., the plurality of protrusions 311 of FIG. 3A) instead of the second groove 610 and/or the third groove 620 is disposed on the second lateral side 212 and the fourth lateral side 221, the electronic device 101 may be configured such that the user easily changes the electronic device 101 from the plurality of folded states to the unfolded state through the pattern 310.

FIG. 7A illustrates a portion of an electronic device in a first folded state. FIG. 7B is a top plan view of an electronic device in a first folded state.

Referring to FIGS. 7A and 7B, an electronic device 101 may include a first housing 210 including a first surface (e.g., the first surface 210a of FIG. 2A) and a first set of lateral sides 201 extending from the first surface 210a, a second housing 220 including a second surface (e.g., the second surface 220a of FIG. 2A), a third housing 230 including a third surface (e.g., the third surface 230a of FIG. 2A), and a flexible display 240 disposed on the first surface 210a, the second surface 220a, and the third surface 230a. The electronic device 101 may include a first hinge structure (e.g., the first hinge structure 250 of FIG. 2A), disposed between the first housing 210 and the second housing 220 and rotatably connecting the first housing 210 and the second housing 220, and a second hinge structure 260, disposed between the second housing 220 and the third housing 230 and rotatably connecting the second housing 220 and the third housing 230. The first hinge structure 250 and the second hinge structure 260 may be configured to provide an unfolded state in which the first surface 210a, the second surface 220a, and the third surface 230a face the same direction, and a plurality of folded states in which at least one of the first surface 210a, the second surface 220a, and the third surface 230a faces a different direction. The first set of lateral sides 201 may include a first lateral side 211, including a pattern 310 including a plurality of protrusions 311, and configured to face at least a portion of the flexible display 240 in the plurality of folded states.

According to an embodiment, the first housing 210 may include an edge region 710 in which the first set of lateral sides 201 are connected to each other, and a hole 720 formed in the edge region 710. For example, the edge region 710 may be disposed along the first lateral side 211. For example, the edge region 710 may be a region including both ends (e.g., both ends 211a and 211b of FIG. 4A) of the first lateral side 211. For example, the edge region 710 may include a first edge region 711 including an edge in which the first lateral side 211 and the second lateral side 212 are in contact with each other, and a second edge region 712 including an edge in which the first lateral side 211 and the third lateral side 213 facing the second lateral side 212 are in contact with each other. For example, the edge region 710 may include an inner space of the first housing 210 formed by an edge of the first housing 210.

For example, the hole 720 may extend from the inner space of the first housing 210 to at least a portion of the first set of lateral sides 201 in the edge region 710. The inner space of the first housing 210 may be exposed (e.g., audibly, visually, etc.) to outside the first housing 210 by the hole 720. The first housing 210 may be configured to guide a state change of the electronic device 101 by a user while the electronic device 101 is changed from the first folded state to the unfolded state, by including the hole 720.

According to an embodiment, the electronic device 101 may further include a speaker 730 as an internal component disposed at the edge region 710 of the first housing 210 and configured to output audio, and a duct 740 extending from the speaker 730 to the hole 720 for the speaker 730. For example, the hole 720 may be a path through which the audio outputted from the speaker 730 is transmitted to the outside of the electronic device 101. In terms of the audio outputted from the speaker 730 being transmitted to the outside through the hole 720, the hole 720 may be referred to as a speaker hole of the electronic device 101. For example, the duct 740 may extend from a portion (e.g., a diaphragm) where the audio of the speaker 730 is outputted to the hole 720. The duct 740 may be a path through which the audio outputted from the speaker 730 is transmitted. For example, when referring to FIG. 7B, the speaker 730 may be disposed in the first edge region 711 including at least a portion of the first lateral side 211 and at least a portion of the second lateral side 212. Since the hole 720 is formed at the second lateral side 212 in the first edge region 711, the audio outputted from the speaker 730 may be transmitted to the outside through the duct 740 in the first edge region 711 and the hole 720. The electronic device 101 may be configured to guide a state change of the electronic device 101 by the user while the electronic device 101 is changed from the first folded state to the unfolded state by including the hole 720 that may function as a speaker hole.

According to the above-described embodiment, the electronic device 101 may be configured to guide a state change of the electronic device 101 by the user while the electronic device 101 is changed from the first folded state to the unfolded state, by including the hole 720 that may function as a speaker hole. That is, the hole 720 and/or the duct 740 may function as a groove or recess at which an external tool (like a hand, finger, etc. of a body) may contact or apply a force to the electronic device 101 for rotating the first housing 210 in a direction away from the second housing 220.

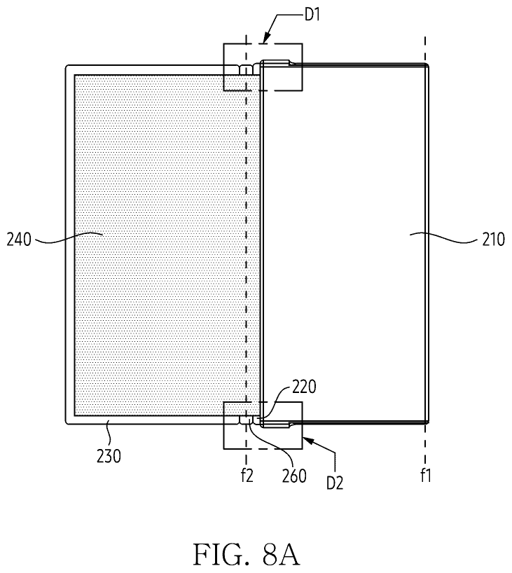

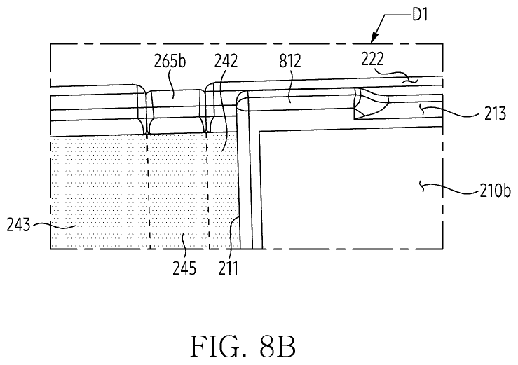

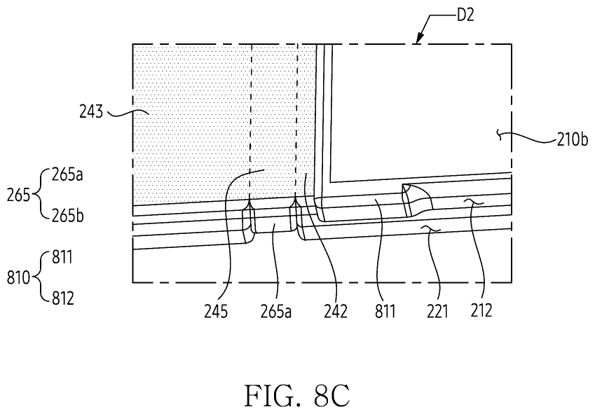

FIG. 8A illustrates a perspective view of an electronic device in a first folded state according to an embodiment. FIGS. 8B and 8C illustrate enlarged perspective views of portions of the electronic device of FIG. 8A. FIGS. 8B and 8C are enlarged perspective views of regions D1 and D2 of FIG. 8A, respectively.

Referring to FIGS. 8A to 8C, an electronic device 101 may include a first housing 210 including a first surface (e.g., the first surface 210a of FIG. 2A) and a first set of lateral sides 201 (e.g., the first set of lateral sides 201 of FIG. 2A) extending from the first surface 210a, a second housing 220 including a second surface (e.g., the second surface 220a of FIG. 2A), a third housing 230 including a third surface (e.g., the third surface 230a of FIG. 2A), and a flexible display 240 disposed on the first surface 210a, the second surface 220a, and the third surface 230a. The electronic device 101 may include a first hinge structure (e.g., the first hinge structure 250 of FIG. 2A), disposed between the first housing 210 and the second housing 220 and rotatably connecting the first housing 210 and the second housing 220, and a second hinge structure 260, disposed between the second housing 220 and the third housing 230 and rotatably connecting the second housing 220 and the third housing 230. The first hinge structure 250 and the second hinge structure 260 may be configured to provide an unfolded state in which the first surface 210a, the second surface 220a, and the third surface 230a face the same direction, and a plurality of folded states in which at least one of the first surface 210a, the second surface 220a, and the third surface 230a faces a different direction. The first set of lateral sides 201 may include a first lateral side 211, including a pattern 310 including a plurality of protrusions 311, and configured to face at least a portion of the flexible display 240 in the plurality of folded states. According to an embodiment, the first set of lateral sides 201 may include a second lateral side 212 in contact with the first lateral side 211, and a third lateral side 213 facing the second lateral side 212. A length (e.g., the d2 of FIG. 2B) of the second lateral side 212 and a length (e.g., the d3 of FIG. 2B) of the third lateral side 213 may be shorter than a length (e.g., the d1 of FIG. 2B) of the first lateral side 211.

According to an embodiment, the first housing 210 may further include at least one protrusion 810 protruding from at least a portion of the first set of lateral sides 201. For example, the first housing 210 may include a first protrusion 811 protruding from the second lateral side 212, and a second protrusion 812 protruding from the third lateral side 213. The protrusions may be a portion of the body of the first housing 210 that protrude further than a respective lateral side. For example, the first protrusion 811 may protrude from the second lateral side 212 and an end (e.g., the end 211a of FIG. 4A) of the first lateral side 211. For example, the second protrusion 812 may protrude from the third lateral side 213 and another end (e.g., the other end 211b of FIG. 4A) of the first lateral side 211. For example, the at least one protrusion 810 may be formed in an edge region (e.g., the edge region 710 of FIGS. 7A and 7B). For example, the first protrusion 811 may protrude from a fourth lateral side 221 of the second housing 220 when a fourth surface 210b is viewed from above in the first folded state. For example, the second protrusion 812 may protrude from a fifth lateral side 222 of the second housing 220 when the fourth surface 210b is viewed from above in the first folded state. The first housing 210 may be configured to assist a grip of a user while the electronic device 101 is changed from the first folded state to the unfolded state, by including the at least one protrusion 810.

According to the above-described embodiment, the electronic device 101 may be configured to assist the grip of the user while the electronic device 101 is changed from the first folded state to the unfolded state, by including the at least one protrusion 810.

According to the above-described embodiment, a multi foldable electronic device (e.g., the electronic device 101 of FIG. 1) may include a first housing (e.g., the first housing 210 of FIG. 2A) including a first surface (e.g., the first surface 210a of FIG. 2A) and a first lateral side (e.g., the first side surface 211 of FIG. 2A). The multi foldable electronic device may include a second housing (e.g., the second housing 220 of FIG. 2A), including a second surface (e.g., the second surface 220a of FIG. 2A), rotatably coupled with the first housing. The multi foldable electronic device may include a third housing (e.g., the third housing 230 of FIG. 2A), including a third surface (e.g., the third surface 230a of FIG. 2A), rotatably coupled with respect to the second housing. The multi foldable electronic device may include a flexible display (e.g., the flexible display 240 of FIG. 2A), disposed on the first surface, the second surface, and the third surface, and including a first display area (e.g., the first display area 241 of FIG. 2A) disposed on the first surface, a second display area (e.g., the second display area 242 of FIG. 2A) disposed on the second surface, and a third display area (e.g., the third display area 243 of FIG. 2A) disposed on the third surface. The multi foldable electronic device may include a first hinge structure (e.g., the first hinge structure 250 of FIG. 2A), disposed between the first housing and the second housing and rotatably connecting the first housing and the second housing, and a second hinge structure (e.g., the second hinge structure 260 of FIG. 2A), disposed between the second housing and the third housing and rotatably connecting the second housing and the third housing. The first hinge structure and the second hinge structure may be configured to provide an unfolded state and a plurality of folded states, the plurality of folded states including a first folded state in which the first housing and the second housing are folded to each other, and a second folded state in which the second housing and the third housing are folded to each other. A width (e.g., the width w1 of FIG. 2A) between the first surface and the second surface of the first hinge structure may be narrower than a width (e.g., the width w2 of FIG. 2A) between the second surface and the third surface of the second hinge structure. The first lateral side may be configured to include a pattern including a plurality of protrusions (e.g., the plurality of protrusions 311 of FIG. 3A). According to the above-mentioned embodiment, the first lateral side may be configured to assist a grip of a user while the multi foldable electronic device is changed from the first folded state to the unfolded state by including the pattern including the plurality of protrusions. The above-mentioned embodiment may have various effects including the above-mentioned effect.

In an embodiment, the first housing and the second housing rotatably folded to face each other at the first hinge structure defines a first folded state of the multi foldable electronic device. The first housing and the second housing rotatably folded to face each other at the first hinge structure together with the second housing and the third housing rotatably folded to face each other at the second hinge structure defines a second folded state of the multi foldable electronic device. Here, in each the first folded state and the second folded state as a plurality of folded states, the first lateral side is configured to face the flexible display and the support portion of the second hinge structure is configured to face the first lateral side.

According to an embodiment, the pattern may further include a plurality of grooves (e.g., the plurality of grooves 312 of FIG. 3C) formed between the plurality of protrusions. According to the above-mentioned embodiment, the pattern may be configured to assist the grip of the user while the multi foldable electronic device is changed from the first folded state to the unfolded state by including the plurality of grooves between the plurality of protrusions. The above-mentioned embodiment may have various effects including the above-mentioned effect.

According to an embodiment, the first housing may further include a first rib (e.g., the first rib 411 of FIG. 4A) protruding from an end (e.g., the end 211a of FIG. 4A) of the first lateral side, and a second rib (e.g., the second rib 412 of FIG. 4A) protruding from another end (e.g., the other end 211b of FIG. 4A) of the first lateral side opposite to the end of the first lateral side. The first rib and the second rib may be configured to separate the flexible display from the first lateral side by contacting the second hinge structure in the plurality of folded states. According to the above-mentioned embodiment, the first housing may reduce damage to the flexible display by including the first rib and the second rib. The above-mentioned embodiment may have various effects including the above-mentioned effect.

In an embodiment, the first folded state and/or the second folded state may include the flexible display separated from the first lateral side by the first rib and the second rib contacting the second hinge structure.

According to an embodiment, the second hinge structure may include a support portion (e.g., the support portion 265 of FIG. 4A) exposed to outside of the multi foldable electronic device and configured to face with the first lateral side. The support portion may be spaced apart from the first lateral side, in the first folded state among the plurality of folded states, in which the second surface and the third surface face a first direction, and the first surface faces a second direction opposite to the first direction. The support portion may be contacted with the first lateral side in the second folded state among the plurality of folded states, in which the second surface faces the first direction and, the first surface and the third surface face the second direction opposite to the first direction. According to the above-mentioned embodiment, the second hinge structure may reduce damage to the flexible display by including the support portion. The above-mentioned embodiment may have various effects including the above-mentioned effect.

In an embodiment, the first folded state may further include the second surface and the third surface facing a first direction together with the first surface facing a second direction opposite to the first direction, and the support portion of the second hinge structure spaced apart from the first lateral side. The second folded state may further include the second housing and the third housing rotatably folded to face each other together with the second surface facing the first direction, both the first surface and the third surface facing the second direction, and the support portion of the second hinge structure contacted with the first lateral side.

According to an embodiment, the first lateral side may further include an inclined surface (e.g., the inclined surface 211c of FIG. 4A) having an incline with respect to the first surface. According to the above-mentioned embodiment, the first lateral side may be configured to assist the grip of the user while the multi foldable electronic device is changed from the first folded state to the unfolded state by including the inclined surface. The above-mentioned embodiment may have various effects including the above-mentioned effect.

According to an embodiment, the first housing may further include a first groove (e.g., the first groove 510 of FIG. 5A) formed at the first lateral side. According to the above-mentioned embodiment, the first housing may be configured to assist the grip of the user while the multi foldable electronic device is changed from the first folded state to the unfolded state by including the first groove. The above-mentioned embodiment may have various effects including the above-mentioned effect.

According to an embodiment, the first housing may further include a second lateral side (e.g., the second lateral side 212 of FIG. 2A) in contact with the first lateral side, and a third lateral side (e.g., the third lateral side 213 of FIG. 2A), in contact with the first lateral side, facing the second lateral side. A length (e.g., the d2 of FIG. 2B) of the second lateral side and a length (e.g., the d3 of FIG. 2B) of the third lateral side may be shorter than a length (e.g., the d1 of FIG. 2B) of the first lateral side, respectively. According to the above-mentioned embodiment, the first housing may be configured to assist the grip of the user while the multi foldable electronic device is changed from the first folded state to the unfolded state by having the length of the first lateral side longer than the length of the second lateral side and the length of the third lateral side. The above-mentioned embodiment may have various effects including the above-mentioned effect.

According to an embodiment, the first housing may further include a first protrusion (e.g., the first protrusion 811 of FIGS. 8A to 8C) protruding from the second lateral side, and a second protrusion (e.g., the second protrusion 812 of FIGS. 8A to 8C) protruding from the third lateral side. According to the above-mentioned embodiment, the first housing may be configured to assist the grip of the user while the multi foldable electronic device is changed from the first folded state to the unfolded state by including the first protrusion and the second protrusion. The above-mentioned embodiment may have various effects including the above-mentioned effect.

According to an embodiment, the first housing may further include a second lateral side in contact with the first lateral side. The first housing may further include a second groove (e.g., the second groove 610 of FIG. 6A) formed at the second lateral side. According to the above-mentioned embodiment, the first housing may be configured to assist the grip of the user while the multi foldable electronic device is changed from the first folded state to the unfolded state by including the second groove. The above-mentioned embodiment may have various effects including the above-mentioned effect.

According to an embodiment, the second housing may further include a fourth lateral side (e.g., the fourth lateral side 221 of FIG. 2A) facing the same direction as a direction in which the second lateral side faces, in the unfolded state, and a third groove (e.g., the third groove 620 of FIG. 6A) formed at the fourth lateral side and paired with the second groove. According to the above-mentioned embodiment, the multi foldable electronic device may be configured to assist the grip of the user while the multi foldable electronic device is changed from the first folded state to the unfolded state by including the second groove and the third groove. The above-mentioned embodiment may have various effects including the above-mentioned effect.

In an embodiment, the first folded state may further include the second groove of the first housing facing the third groove of the second housing.

According to an embodiment, the flexible display may further include a fourth display area (e.g., the fourth display area 244 of FIG. 2A), on the first hinge structure, configured to be deformable, and a fifth display area (e.g., the fifth display area 245 of FIG. 2A), on the second hinge structure, configured to be deformable. The first display area may face the second display area, in the first folded state among the plurality of folded states, in which the second surface and the third surface face a first direction, and the first surface faces a second direction opposite to the first direction. The fifth display area may face the first lateral side, in the second folded state among the plurality of folded states, in which the second surface faces the first direction, and the first surface and the third surface face the second direction opposite to the first direction. According to the above-mentioned embodiment, the multi foldable electronic device may provide a variety of user experiences to the user by being configured the first display area to face the second display area in the first folded state and the fifth display area to face the first lateral side in the second folded state. The above-mentioned embodiment may have various effects including the above-mentioned effect.

In an embodiment, the first folded state may further include the second surface and the third surface facing a first direction together with the first display area facing a second direction opposite to the first direction and facing the second display area. The second folded state may further include the second housing and the third housing rotatably folded to face each other together with the second surface facing the first direction, both the first surface and the third surface facing the second direction, and the fourth display area facing the first lateral side of the first housing.

According to an embodiment, the first housing may further include an edge region (e.g., the edge region 710 of FIG. 7A) including both ends of the first lateral side, and a hole (e.g., the hole 720 of FIG. 7A) formed at the edge region. According to the above-mentioned embodiment, the first housing may be configured to assist the grip of the user while the multi foldable electronic device is changed from the first folded state to the unfolded state by including the hole formed in the edge region. The above-mentioned embodiment may have various effects including the above-mentioned effect.

According to an embodiment, the multi foldable electronic device may further include a speaker (e.g., the speaker 730 of FIG. 7B) disposed in the edge region of the first housing and configured to output audio, and a duct (e.g., the duct 740 of FIG. 7B) extending from the speaker to the hole for the speaker. According to the above-mentioned embodiment, the first housing may be configured to assist the grip of the user while the multi foldable electronic device is changed from the first folded state to the unfolded state by including the hole formed in the edge region. The above-mentioned embodiment may have various effects including the above-mentioned effect.

According to an embodiment, the second hinge structure may include a third rib (e.g., the third rib 421 of FIG. 4A) configured to contact an end of the first lateral side, and a fourth rib (e.g., the fourth rib 422 of FIG. 4A) configured to contact another end of the first lateral side opposite to the end of the first lateral side. According to the above-mentioned embodiment, the second hinge structure may reduce damage to the flexible display by including the third rib and the fourth rib. The above-mentioned embodiment may have various effects including the above-mentioned effect.

According to an embodiment, the first housing may include an elastic member (e.g., the clastic member 320 of FIG. 3A), forming the plurality of protrusions, configured to be deformable. According to the above-mentioned embodiment, the first housing may reduce damage to the flexible display by including the clastic member. The above-mentioned embodiment may have various effects including the above-mentioned effect.

According to an embodiment, a multi foldable electronic device may include a first housing including a first surface, and lateral sides extending from the first surface, a second housing including a second surface, a third housing including a third surface, and a flexible display disposed on the first surface, the second surface, and the third surface. The multi foldable electronic device may include a first hinge structure, disposed between the first housing and the second housing and rotatably connecting the first housing and the second housing, and a second hinge structure, disposed between the second housing and the third housing and rotatably connecting the second housing and the third housing. The first hinge structure and the second hinge structure may be configured to provide an unfolded state in which the first surface, the second surface, and the third surface face the same direction, and a plurality of folded states in which at least one of the first surface, the second surface, and the third surface face a different direction. The lateral sides may include a plurality of protrusions, a pattern including a plurality of grooves formed between the plurality of protrusions, and an inclined surface having an incline with respect to the first surface, and a first lateral side configured to face at least a portion of the flexible display in the plurality of folded states. According to the above-mentioned embodiment, the first lateral side may be configured to assist a grip of a user while the multi foldable electronic device is change from the first folded state to the unfolded state by including the plurality of protrusions, the pattern including the plurality of grooves, and the inclined surface. The above-mentioned embodiment may have various effects including the above-mentioned effect.

According to an embodiment, the first housing may include a first rib protruding from an end of the first lateral side, and a second rib protruding from another end of the first lateral side opposite to the end of the first lateral side. The first rib and the second rib may be configured to separate the flexible display from the first lateral side by contacting the second hinge structure in the plurality of folded states. According to the above-mentioned embodiment, the first housing may reduce damage to the flexible display by including the first rib and the second rib. The above-mentioned embodiment may have various effects including the above-mentioned effect.

According to an embodiment, the second hinge structure may include a support portion exposed to outside of the multi foldable electronic device and configured to face with the first lateral side. The support portion may be spaced apart from the first lateral side, in the first folded state among the plurality of folded states, in which the second surface and the third surface face a first direction, and the first surface faces a second direction opposite to the first direction. The support portion may be contacted with the first lateral side in the second folded state among the plurality of folded states, in which the second surface faces the first direction and, the first surface and the third surface face the second direction opposite to the first direction. According to the above-mentioned embodiment, the second hinge structure may reduce damage to the flexible display by including the support portion. The above-mentioned embodiment may have various effects including the above-mentioned effect.

According to an embodiment, the first housing may include an edge region including both ends of the first lateral side, a hole formed at the edge region, a speaker disposed in the edge region of the first housing and configured to output audio, and a duct extending from the speaker to the hole for the speaker. According to the above-mentioned embodiment, the first housing may be configured to assist the grip of the user while the multi foldable electronic device is changed from the first folded state to the unfolded state by including the hole formed in the edge region. The above-mentioned embodiment may have various effects including the above-mentioned effect.

According to an embodiment, the first housing may include a second lateral side in contact with the first lateral side, and a third lateral side in contact with the first lateral side and facing with the second lateral side. A length of the second lateral side and a length of the third lateral side may be shorter than a length of the first lateral side, respectively. According to the above-mentioned embodiment, the first housing may be configured to assist the grip of the user while the multi foldable electronic device is changed from the first folded state to the unfolded state by having the length of the first side surface longer than the length of the second side surface and the length of the third side surface. The above-mentioned embodiment may have various effects including the above-mentioned effect.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements.

It will be understood that when an element is referred to as being related to another element such as being “on” another element, it can be directly on the other element or intervening elements may be present therebetween. In contrast, when an element is referred to as being related to another element such as being “directly on” another element, there are no intervening elements present.

It is to be understood that a singular form of a noun corresponding to an item may include one or more of the things unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of or all possible combinations of the items enumerated together in a corresponding one of the phrases. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

As used herein, such terms as “1st” and “2nd,” or “first” and “second” may be used to simply distinguish a corresponding component from another, and does not limit the components in other aspect (e.g., importance or order).

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The terms “below” or “beneath” can, therefore, encompass both an orientation of above and below.

It is to be understood that if an element (e.g., a first element) is referred to, with or without the term “operatively” or “communicatively”, as “coupled with,” or “connected with” another element (e.g., a second element), it means that the element may be coupled with the other element directly (e.g., wiredly), wirelessly, or via a third element.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within +30%, 20%, 10% or 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between a case in which data is semi-permanently stored in the storage medium and a case in which the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

No claim element is to be construed under the provisions of 35 U.S.C. § 112, sixth paragraph, unless the element is expressly recited using the phrase “means for” or “means.”

What is claimed is:

1. A multi foldable electronic device comprising:
a first housing including:
a first surface,
a first lateral side extended from the first surface; and
a second housing including a second surface;
a third housing, including a third surface;
a flexible display including a first display area disposed on the first surface, a second display area disposed on the second surface, and a third display area disposed on the third surface;
a first hinge structure rotatably connecting the first housing and the second housing; and
a second hinge structure rotatably connecting the second housing and the third housing,
wherein the first hinge structure and the second hinge structure are configured to provide an unfolded state and a plurality of folded states of the multi foldable electronic device, the plurality of folded states including a first folded state in which the first housing and the second housing are rotatably folded to face each other, and
wherein a width of the first hinge structure is narrower than a width of the second hinge structure, and
wherein the first lateral side includes a pattern including a plurality of protrusions.

2. The multi foldable electronic device of claim 1, wherein the pattern includes a plurality of grooves defined between the plurality of protrusions.

3. The multi foldable electronic device of claim 1,
wherein the first housing includes:
a first rib protruding further from the first lateral side at an end of the first lateral side, and
a second rib protruding further from the first lateral side at another end of the first lateral side which is opposite to the end of the first lateral side, and
wherein the first rib and the second rib are configured to separate the flexible display from the first lateral side by contacting the second hinge structure when the multi foldable electronic device is in a folded state among the plurality of folded states.

4. The multi foldable electronic device of claim 1,
wherein the second hinge structure includes a support portion exposed to outside of the multi foldable electronic device and configured to face with the first lateral side, and
wherein the support portion is spaced apart from the first lateral side, in the first folded state among the plurality of folded states, in which the second surface and the third surface face a first direction, and the first surface faces a second direction opposite to the first direction, and
wherein the support portion is contacted with the first lateral side in the second folded state among the plurality of folded states, in which the second surface faces the first direction and, the first surface and the third surface face the second direction opposite to the first direction.

5. The multi foldable electronic device of claim 1, wherein the first lateral side of the first housing includes an inclined surface inclined with respect to the first surface of the first housing.

6. The multi foldable electronic device of claim 1, wherein the first housing includes a first groove defined recessed from the first lateral side.

7. The multi foldable electronic device of claim 1, wherein the first housing includes:
a second lateral side in contact with the first lateral side and the first surface,
a third lateral side in contact with the first lateral side and the first surface, and facing the second lateral side, and
a length of the second lateral side and a length of the third lateral side shorter than a length of the first lateral side, respectively.

8. The multi foldable electronic device of claim 7, wherein the first housing includes:
a first protrusion protruding from the second lateral side, and
a second protrusion protruding from the third lateral side.

9. The multi foldable electronic device of claim 1, wherein the first housing includes:
a second lateral side in contact with the first lateral side and the first surface, and
a second groove defined recessed from the second lateral side.

10. The multi foldable electronic device of claim 9,
wherein the second housing includes:
a fourth lateral side at a same side of the multi foldable electronic device as the second lateral side of the first housing, and
a third groove defined recessed from the fourth lateral side, and
wherein the first folded state includes the second groove of the first housing facing the third groove of the second housing.

11. The multi foldable electronic device of claim 1,
wherein the flexible display includes:
a fourth display area, disposed on the first hinge structure, configured to be deformable, and
a fifth display area, disposed on the second hinge structure, configured to be deformable,
wherein the first display area faces the second display area, in the first folded state among the plurality of folded states, in which the second surface and the third surface face a first direction, and the first surface faces a second direction opposite to the first direction,
wherein the fifth display area faces the first lateral side, in the second folded state among the plurality of folded states, in which the second surface faces the first direction, and the first surface and the third surface face the second direction opposite to the first direction.

12. The multi foldable electronic device of claim 1, wherein the first housing includes:
an edge region at an end among opposing ends of the first lateral side, and
a hole defined in the first housing at the edge region.

13. The multi foldable electronic device of claim 12, further comprising:
a speaker in the first housing at the edge region of the first housing and configured to output audio, and
a duct extending from the speaker to the hole.

14. The multi foldable electronic device of claim 1, wherein the second hinge structure includes:
a third rib configured to contact an end of the first lateral side, and
a fourth rib configured to contact another end of the first lateral side which is opposite to the end of the first lateral side.

15. The multi foldable electronic device of claim 1, wherein the first housing includes an elastic member defining the plurality of protrusions.

16. A multi foldable electronic device comprising:
a flexible display;
a first housing including:
a first surface facing the flexible display,
lateral sides extending from the first surface, the lateral sides including:
a first lateral side having an inclined surface inclined with respect to the first surface, and
a plurality of protrusions protruded from the first lateral side, the plurality of protrusions defining a plurality of grooves between the plurality of protrusions;
a second housing including a second surface facing the flexible display;
a third housing including a third surface facing the flexible display;
a first hinge structure rotatably connecting the first housing to the second housing; and
a second hinge structure rotatably connecting the second housing to the third housing,
wherein the first hinge structure and the second hinge structure are configured to provide each of:
an unfolded state of the multi foldable electronic device in which the first surface, the second surface and the third surface face the same direction, and
a plurality of folded states of the multi foldable electronic device in which at least one of the first surface, the second surface and the third surface face a different direction from another one of the first surface, the second surface and the third surface, and
wherein in the plurality of folded states, the first lateral side is configured to face the flexible display.

17. The multi foldable electronic device of claim 16,
wherein the first housing includes:
a first rib protruding further from the first lateral side at an end of the first lateral side, and
a second rib protruding further from the first lateral side at another end of the first lateral side which is opposite to the end of the first lateral side, and
wherein the first rib and the second rib are configured to separate the flexible display from the first lateral side by contacting the second hinge structure when the multi foldable electronic device is in a folded state among the plurality of folded states.

18. The multi foldable electronic device of claim 16,
wherein the second hinge structure includes support portion exposed to outside of the multi foldable electronic device, and
wherein the plurality of folded states includes:
the support portion of the second hinge structure facing the first lateral side,
a first folded state in which the support portion is spaced apart from the first lateral side together with the second surface and the third surface facing a first direction, and the first surface facing a second direction opposite to the first direction, and
a second folded state in which the support portion is contacted with the first lateral side together with the second surface facing the first direction, and the first surface and the third surface facing the second direction.

19. The multi foldable electronic device of claim 16, wherein the first housing includes:
an edge region at an end among opposing ends of the first lateral side,
a hole defined in the first housing at the edge region,
a speaker in the first housing at the edge region of the first housing and configured to output audio, and
a duct extending from the speaker to the hole.

20. The multi foldable electronic device of claim 16, wherein the lateral sides of the first housing include:
a second lateral side contacting the first lateral side and the first surface,
a third lateral side contacting the first lateral side and the first surface, the third lateral side facing the second lateral side, and
a length of the second lateral side and a length of the third lateral side are shorter than a length of the first lateral side, respectively.
